(19) United States
(12) Patent Application Publication
(10) Pub. No.: US 2024/0260075 A1
(43) Pub. Date: Aug. 1, 2024

(54) TECHNIQUES FOR PERFORMING QUALITY OF SERVICE MANAGEMENT FOR SIDELINK COMMUNICATIONS

(71) Applicant: QUALCOMM Incorporated, San Diego, CA (US)

(72) Inventors: Karthika PALADUGU, Hyderabad (IN); Hong CHENG, Basking Ridge, NJ (US); Peng CHENG, Beijing (CN)

(21) Appl. No.: 18/560,617

(22) PCT Filed: Jul. 26, 2021
(86) PCT No.: PCT/CN2021/108324

§ 371 Date: Nov. 13, 2023

(51) Int. Cl. H04W 72/543; H04W 76/14; H04W 88/04

(52) U.S. Cl. CPC H04W 72/543; H04W 76/14; H04W 88/04

(57) ABSTRACT

Methods, systems, and devices for wireless communications are described. A remote user equipment (UE) may establish a first connection with a relay UE that is in communication with a base station via a second connection. The first connection may be of a first connection type and the second connection may be of a second connection type. The remote UE may identify a mapping between one or more first quality of service (QOS) parameters corresponding to the first connection type and one or more second QoS parameters corresponding to the second connection type. The remote UE may determine, using the mapping, a first QoS parameter to be applied to the first connection as part of an end-to-end (E2E) connection with the base station via the relay UE, and communicate with the base station via the relay UE using the E2E connection.

### CROSS REFERENCE

The present Application is a 371 national stage filing of International PCT Application No. PCT/CN2021/108324 by PALADUGU et al. entitled “TECHNIQUES FOR PERFORMING QUALITY OF SERVICE MANAGEMENT FOR SIDELINK COMMUNICATIONS,” filed Jul. 26, 2021, which is assigned to the assignee hereof, and which is expressly incorporated by reference in its entirety herein.

### FIELD OF TECHNOLOGY

The following relates to wireless communications, including techniques for performing quality of service (QOS) management for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a first UE may establish a connection with a base station via a second UE. The second UE may have an established connection with the base station. Accordingly, to establish the connection with the base station via the second UE, the first UE may establish a connection with the second UE. The second UE may act as a relaying UE between the first UE and the base station so that the first UE and the base station may communicate. Techniques for establishing the connection between the first UE and the base station may be improved.

### SUMMARY

The described techniques relate to improved methods, systems, devices, and apparatuses that support techniques for performing quality of service (QOS) management for sidelink communications. Generally, the described techniques provide for improved methods of establishing a connection for a remote UE while maintaining a QoS. The improved methods may include a remote user equipment (UE) establishing a first connection with a relay UE that is in communication with a base station via a second connection. The first connection may be of a first connection type (e.g., sidelink communication type, PC5 communication type, Wi-Fi, Bluetooth, device-to-device, peer-to-peer) and the second connection may be of a second connection type (e.g., Uu communication type). The remote UE may identify a mapping between one or more first QoS parameters corresponding to the first connection type and one or more second QoS parameters corresponding to the second connection type. The remote UE may determine, using the mapping, a first QoS parameter to be applied to the first connection as part of an end-to-end (E2E) connection with the base station via the relay UE, and communicate with the base station via the relay UE using the E2E connection.

From the perspective of a relay UE, the improved methods may include the relay UE establishing a first connection with a remote UE, where the relay UE may be in communication with a base station via a second connection. The first connection may be of a first connection type (e.g., sidelink communication type, PC5 communication type) and the second connection may be of a second connection type (e.g., Uu communication type). The relay UE may identify a mapping between one or more first QoS parameters corresponding to the first connection type and one or more second QoS parameters corresponding to the second connection type. The relay UE may determine, using the mapping, a first QoS parameter to be applied to the first connection as part of an end-to-end connection between the base station and remote UE via the relay UE. The relay UE may relay communications between the base station and the remote UE using the end-to-end connection.

In some cases, the improved methods may include a network device (e.g., base station, node, network entity) establishing an E2E connection with a remote UE via a relay UE, where the E2E connection may include a first connection and a second connection. The network device may be in communication with the relay UE via the second connection and the relay UE may be in communication with the remote UE via the first connection, where the first connection may be of a first connection type (e.g., sidelink communication type, PC5 communication type) and the second connection being of a second connection type (e.g., Uu communication type). The network device may identify a mapping between one or more first QoS parameters corresponding to the first connection type and one or more second QoS parameters corresponding to the second connection type, and communicate with the remote UE via the relay UE using the end-to-end connection.

A method for wireless communications at a first wireless device is described. The method may include establishing a first connection with a second wireless device that is in communication with a network entity via a second connection, where the first connection is of a first connection type and the second connection is of a second connection type, identifying a mapping between one or more first QoS parameters corresponding to the first connection type and one or more second QoS parameters corresponding to the second connection type, determining, using the mapping, a first QoS parameter to be applied to the first connection as part of an end-to-end connection with the network entity via the second wireless device, and communicating with the network entity via the second wireless device using the end-to-end connection.

An apparatus for wireless communications at a first wireless device is described. The apparatus may include a processor, memory coupled with the processor, and instructions stored in the memory. The instructions may be executable by the processor to cause the apparatus to establish a first connection with a second wireless device that is in communication with a network entity via a second connection, where the first connection is of a first connection type and the second connection is of a second connection type, identify a mapping between one or more first QoS parameters corresponding to the first connection type and one or more second QoS parameters corresponding to the second connection type, determine, using the mapping, a first QoS parameter to be applied to the first connection as part of an end-to-end connection with the network entity via the second wireless device, and communicate with the network entity via the second wireless device using the end-to-end connection.

Another apparatus for wireless communications at a first wireless device is described. The apparatus may include means for establishing a first connection with a second wireless device that is in communication with a network entity via a second connection, where the first connection is of a first connection type and the second connection is of a second connection type, means for identifying a mapping between one or more first QoS parameters corresponding to the first connection type and one or more second QoS parameters corresponding to the second connection type, means for determining, using the mapping, a first QoS parameter to be applied to the first connection as part of an end-to-end connection with the network entity via the second wireless device, and means for communicating with the network entity via the second wireless device using the end-to-end connection.

A non-transitory computer-readable medium storing code for wireless communications at a first wireless device is described. The code may include instructions executable by a processor to establish a first connection with a second wireless device that is in communication with a network entity via a second connection, where the first connection is of a first connection type and the second connection is of a second connection type, identify a mapping between one or more first QoS parameters corresponding to the first connection type and one or more second QoS parameters corresponding to the second connection type, determine, using the mapping, a first QoS parameter to be applied to the first connection as part of an end-to-end connection with the network entity via the second wireless device, and communicate with the network entity via the second wireless device using the end-to-end connection.

Some examples of the method, apparatuses, and non-transitory computer-readable medium described herein may further include operations, features, means, or instructions for receiving an indication of the mapping between the one or more first QoS parameters corresponding to the first connection type and the one or more second QoS parameters corresponding to the second connection type.

In some examples of the method, apparatuses, and non-transitory computer-readable medium described herein, receiving the indication of the mapping may include operations, features, means, or instructions for receiving the indication of the mapping during Proximity Services Policy provisioning by a Policy Control Function.

In some examples of the method, apparatuses, and non-transitory computer-readable medium described herein, receiving the indication of the mapping may include operations, features, means, or instructions for receiving the indication of the mapping in a synchronization signal block, or a radio resource control message.

Some examples of the method, apparatuses, and non-transitory computer-readable medium described herein may further include operations, features, means, or instructions for receiving an indication of the one or more second QoS parameters corresponding to the second connection type, where determining the first QoS parameter to be applied to the first connection may be based on the indication.

In some examples of the method, apparatuses, and non-transitory computer-readable medium described herein, receiving the indication may include operations, features, means, or instructions for receiving, from the second wireless device, a radio resource control reconfiguration message including the indication of the one or more second QoS parameters.

Some examples of the method, apparatuses, and non-transitory computer-readable medium described herein may further include operations, features, means, or instructions for transmitting, to the second wireless device, an indication of the first QoS parameter to be applied to the first connection as part of the end-to-end connection with the network entity via the second wireless device.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between 5QI table entries to PQI table entries.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between second connection QoS flow priority values to first connection QoS flow priority values.

In some examples of the method, apparatuses, and non-transitory computer-readable medium described herein, identifying the mapping may include operations, features, means, or instructions for identifying that the mapping may be associated with the first wireless device in a UE-specific manner, or the mapping may be associated with a set of multiple first wireless devices.

In some examples of the method, apparatuses, and non-transitory computer-readable medium described herein, the first wireless device may be operating in accordance with a resource allocation mode 1 when the first connection may be a sidelink connection type and the method, apparatuses, and non-transitory computer-readable medium may include further operations, features, means, or instructions for transmitting an indication of an end-to-end bearer identifier associated with the first wireless device, the one or more first QoS parameters, an identifier of the second wireless device, a reference signal received power associated with the first connection type, or a combination thereof.

In some examples of the method, apparatuses, and non-transitory computer-readable medium described herein, the one or more first QoS parameters, or the one or more second QoS parameters, or both include a priority of the second connection type, a prioritized bitrate, a value associated with the second connection type, a resource type, a packet delay budget, a packet error rate, a data burst volume, an averaging window, or a combination thereof.

In some examples of the method, apparatuses, and non-transitory computer-readable medium described herein, the one or more second QoS parameters may be based on a 5QI of an end-to-end radio bearer.

In some examples of the method, apparatuses, and non-transitory computer-readable medium described herein, the first connection may be a sidelink connection, a Wi-Fi connection, a Bluetooth connection, a device-to-device connection, or a peer-to-peer connection.

A method for wireless communications at a first wireless device is described. The method may include establishing a first connection with a second wireless device, where the first wireless device is in communication with a network entity via a second connection, the first connection is of a first connection type and the second connection is of a second connection type, identifying a mapping between one or more first QoS parameters corresponding to the first connection type and one or more second QoS parameters corresponding to the second connection type, determining, using the mapping, a first QoS parameter to be applied to the first connection as part of an end-to-end connection between the network entity and second wireless device via the first wireless device, and relaying communications between the network entity and the second wireless device using the end-to-end connection.

An apparatus for wireless communications at a first wireless device is described. The apparatus may include a processor, memory coupled with the processor, and instructions stored in the memory. The instructions may be executable by the processor to cause the apparatus to establish a first connection with a second wireless device, where the first wireless device is in communication with a network entity via a second connection, the first connection is of a first connection type and the second connection is of a second connection type, identify a mapping between one or more first QoS parameters corresponding to the first connection type and one or more second QoS parameters corresponding to the second connection type, determine, using the mapping, a first QoS parameter to be applied to the first connection as part of an end-to-end connection between the network entity and second wireless device via the first wireless device, and relay communications between the network entity and the second wireless device using the end-to-end connection.

Another apparatus for wireless communications at a first wireless device is described. The apparatus may include means for establishing a first connection with a second wireless device, where the first wireless device is in communication with a network entity via a second connection, the first connection is of a first connection type and the second connection is of a second connection type, means for identifying a mapping between one or more first QoS parameters corresponding to the first connection type and one or more second QoS parameters corresponding to the second connection type, means for determining, using the mapping, a first QoS parameter to be applied to the first connection as part of an end-to-end connection between the network entity and second wireless device via the first wireless device, and means for relaying communications between the network entity and the second wireless device using the end-to-end connection.

A non-transitory computer-readable medium storing code for wireless communications at a first wireless device is described. The code may include instructions executable by a processor to establish a first connection with a second wireless device, where the first wireless device is in communication with a network entity via a second connection, the first connection is of a first connection type and the second connection is of a second connection type, identify a mapping between one or more first QoS parameters corresponding to the first connection type and one or more second QoS parameters corresponding to the second connection type, determine, using the mapping, a first QoS parameter to be applied to the first connection as part of an end-to-end connection between the network entity and second wireless device via the first wireless device, and relay communications between the network entity and the second wireless device using the end-to-end connection.

Some examples of the method, apparatuses, and non-transitory computer-readable medium described herein may further include operations, features, means, or instructions for receiving an indication of the mapping between the one or more first QoS parameters corresponding to the first connection type and the one or more second QoS parameters corresponding to the second connection type.

In some examples of the method, apparatuses, and non-transitory computer-readable medium described herein, receiving the indication of the mapping may include operations, features, means, or instructions for receiving the indication of the mapping during Proximity Services Policy provisioning by a Policy Control Function.

In some examples of the method, apparatuses, and non-transitory computer-readable medium described herein, receiving the indication of the mapping may include operations, features, means, or instructions for receiving the indication of the mapping in a synchronization signal block, or a radio resource control message.

Some examples of the method, apparatuses, and non-transitory computer-readable medium described herein may further include operations, features, means, or instructions for transmitting, to the second wireless device, a first indication of the one or more first QoS parameters corresponding to the first connection type.

In some examples of the method, apparatuses, and non-transitory computer-readable medium described herein, transmitting the first indication or the second indication may include operations, features, means, or instructions for transmitting, from the first wireless device, a radio resource control reconfiguration message including the first indication, the second indication, or both.

Some examples of the method, apparatuses, and non-transitory computer-readable medium described herein may further include operations, features, means, or instructions for receiving, from the network entity or the second wireless device, an indication of the one or more second QoS parameters corresponding to the second connection type, where determining the first QoS parameter to be applied to the first connection may be based on the indication.

In some examples of the method, apparatuses, and non-transitory computer-readable medium described herein, receiving the indication may include operations, features, means, or instructions for receiving a radio resource control reconfiguration message including the indication of the one or more second QoS parameters.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between 5QI table entries to PQI table entries.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between second connection QoS flow priority values to first connection QoS flow priority values.

In some examples of the method, apparatuses, and non-transitory computer-readable medium described herein, identifying the mapping may include operations, features, means, or instructions for identifying that the mapping may be associated with the second wireless device in a UE-specific manner, or the mapping may be associated with a set of multiple second wireless devices.

In some examples of the method, apparatuses, and non-transitory computer-readable medium described herein, the first wireless device may be operating in accordance with a random access mode 1 when the first connection may be a sidelink connection type and the method, apparatuses, and non-transitory computer-readable medium may include further operations, features, means, or instructions for transmitting an indication of a bearer identifier of the second wireless device, a reference signal received power associated with the first connection type, or a combination thereof.

Some examples of the method, apparatuses, and non-transitory computer-readable medium described herein may further include operations, features, means, or instructions for determining a first connection type bearer based on a second connection type bearer and transmitting an indication of the second connection type bearer to the second wireless device via a radio resource control reconfiguration message.

Some examples of the method, apparatuses, and non-transitory computer-readable medium described herein may further include operations, features, means, or instructions for utilizing a first connection type bearer configuration for the second wireless device via a radio resource control reconfiguration message.

In some examples of the method, apparatuses, and non-transitory computer-readable medium described herein, the one or more first QoS parameters, or the one or more second QoS parameters, or both include a priority of the second connection type, prioritized bitrates, a value associated with the second connection type, a resource type, a packet delay budget, a packet error rate, a data burst volume, an averaging window, or a combination thereof.

In some examples of the method, apparatuses, and non-transitory computer-readable medium described herein, the one or more second QoS parameters may be based on a 5QI of an end-to-end radio bearer.

A method for wireless communications at a network entity is described. The method may include establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type, identifying a mapping between one or more first QoS parameters corresponding to the first connection type and one or more second QoS parameters corresponding to the second connection type, and communicating with the first wireless device via the second wireless device using the end-to-end connection.

An apparatus for wireless communications at a network entity is described. The apparatus may include a processor, memory coupled with the processor, and instructions stored in the memory. The instructions may be executable by the processor to cause the apparatus to establish an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type, identify a mapping between one or more first QoS parameters corresponding to the first connection type and one or more second QoS parameters corresponding to the second connection type, and communicate with the first wireless device via the second wireless device using the end-to-end connection.

Another apparatus for wireless communications at a network entity is described. The apparatus may include means for establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type, means for identifying a mapping between one or more first QoS parameters corresponding to the first connection type and one or more second QoS parameters corresponding to the second connection type, and means for communicating with the first wireless device via the second wireless device using the end-to-end connection.

A non-transitory computer-readable medium storing code for wireless communications at a network entity is described. The code may include instructions executable by a processor to establish an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type, identify a mapping between one or more first QoS parameters corresponding to the first connection type and one or more second QoS parameters corresponding to the second connection type, and communicate with the first wireless device via the second wireless device using the end-to-end connection.

Some examples of the method, apparatuses, and non-transitory computer-readable medium described herein may further include operations, features, means, or instructions for receiving an indication of the mapping between the one or more first QoS parameters and the one or more second QoS parameters.

In some examples of the method, apparatuses, and non-transitory computer-readable medium described herein, receiving the indication of the mapping may include operations, features, means, or instructions for receiving the indication of the mapping from an access and mobility management Function.

In some examples of the method, apparatuses, and non-transitory computer-readable medium described herein, receiving the indication of the mapping may include operations, features, means, or instructions for receiving the indication of the mapping from a session management function via the access and mobility management Function.

In some examples of the method, apparatuses, and non-transitory computer-readable medium described herein, receiving the indication of the mapping may include operations, features, means, or instructions for receiving the indication of the mapping during a UE Policy Association Establishment procedure, a UE Policy Association Modification procedure, or both.

In some examples of the method, apparatuses, and non-transitory computer-readable medium described herein, receiving the indication of the mapping may include operations, features, means, or instructions for receiving the indication of the mapping during a UE Protocol Data Unit session establishment procedure, a UE Protocol Data Unit session modification procedure, or both.

Some examples of the method, apparatuses, and non-transitory computer-readable medium described herein may further include operations, features, means, or instructions for determining a QoS split between the first connection and the second connection.

In some examples of the method, apparatuses, and non-transitory computer-readable medium described herein, determining the QoS split may include operations, features, means, or instructions for determining the one or more second QoS parameters corresponding to the second connection type based on a 5QI configuration associated with an end-to-end bearer of the first wireless device.

Some examples of the method, apparatuses, and non-transitory computer-readable medium described herein may further include operations, features, means, or instructions for transmitting, to the second wireless device, an indication of the one or more second Qos parameters corresponding to the second connection type.

In some examples of the method, apparatuses, and non-transitory computer-readable medium described herein, transmitting the indication may include operations, features, means, or instructions for transmitting a radio resource control reconfiguration message including the indication of the one or more second QoS parameters.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between 5QI table entries to PQI table entries.

In some examples of the method, apparatuses, and non-transitory computer-readable medium described herein, identifying the mapping may include operations, features, means, or instructions for identifying that the mapping between the one or more first QoS parameters and the one or more second QoS parameters includes an association between second connection QoS flow priority values to first connection QoS flow priority values.

In some examples of the method, apparatuses, and non-transitory computer-readable medium described herein, identifying the mapping may include operations, features, means, or instructions for identifying that the mapping may be associated with the first wireless device in a UE-specific manner, or the mapping may be associated with a set of multiple first wireless devices.

In some examples of the method, apparatuses, and non-transitory computer-readable medium described herein, the first wireless device and the method, apparatuses, and non-transitory computer-readable medium may include further operations, features, means, or instructions for receiving an indication of an end-to-end bearer identifier associated with the first wireless device, the one or more first QoS parameters, an identifier of the second wireless device, a reference signal received power associated with the first connection type, or a combination thereof.

Some examples of the method, apparatuses, and non-transitory computer-readable medium described herein may further include operations, features, means, or instructions for determining the one or more first QoS parameters corresponding to the first connection type based on the indication and the mapping.

Some examples of the method, apparatuses, and non-transitory computer-readable medium described herein may further include operations, features, means, or instructions for determining mode 1 resources for the first connection based on the indication.

In some examples of the method, apparatuses, and non-transitory computer-readable medium described herein, the one or more first QoS parameters, or the one or more second QoS parameters, or both include a priority of the second connection type, prioritized bitrates, a value associated with the second connection type, a resource type, a packet delay budget, a packet error rate, a data burst volume, an averaging window, or a combination thereof.

In some examples of the method, apparatuses, and non-transitory computer-readable medium described herein, the one or more second QoS parameters may be based on a 5QI of an end-to-end radio bearer.

### BRIEF DESCRIPTION OF THE DRAWINGS

FIG. 1 illustrates an example of a wireless communications system that supports techniques for performing quality of service (QOS) management for sidelink communications in accordance with aspects of the present disclosure.

FIG. 2 illustrates an example of a wireless communications system that supports techniques for performing QoS management for sidelink communications in accordance with aspects of the present disclosure.

FIG. 3 illustrates an example of a process flow that supports techniques for performing QoS management for sidelink communications in accordance with aspects of the present disclosure.

FIGS. 4A and 4B illustrate examples of QoS parameter tables that support techniques for performing QoS management for sidelink communications in accordance with aspects of the present disclosure.

FIG. 5 illustrates an example of a process flow that supports techniques for performing QoS management for sidelink communications in accordance with aspects of the present disclosure.

FIGS. 6 and 7 show block diagrams of devices that support techniques for performing QoS management for sidelink communications in accordance with aspects of the present disclosure.

FIG. 8 shows a block diagram of a communications manager that supports techniques for performing QoS management for sidelink communications in accordance with aspects of the present disclosure.

FIG. 9 shows a diagram of a system including a device that supports techniques for performing QoS management for sidelink communications in accordance with aspects of the present disclosure.

FIGS. 10 and 11 show block diagrams of devices that support techniques for performing QoS management for sidelink communications in accordance with aspects of the present disclosure.

FIG. 12 shows a block diagram of a communications manager that supports techniques for performing QOS management for sidelink communications in accordance with aspects of the present disclosure.

FIG. 13 shows a diagram of a system including a device that supports techniques for performing QoS management for sidelink communications in accordance with aspects of the present disclosure.

FIGS. 14 through 19 show flowcharts illustrating methods that support techniques for performing QoS management for sidelink communications in accordance with aspects of the present disclosure.

### DETAILED DESCRIPTION

In some implementations, a first user equipment (UE) (e.g., a first wireless device) may establish a connection with a base station (e.g., network entity, network device) via a second UE. For example, in some cases, the first UE (e.g., a remote UE, a second wireless device) may be out-of-coverage of the base station (e.g., outside an area covered by the base station), but may be near the second UE, where the second UE may be within the area covered by the base station and may have an established connection with the base station. The remote UE may establish a sidelink connection with the second UE (e.g., a relay UE). Accordingly, the relay UE may relay communications between the remote UE and the base station. The relay UE and the remote UE may each be configured with quality of service (QoS) parameters (e.g., priorities, modulation and coding scheme (MCS), packet error rate) for maintaining QoS at the respective UEs. In some cases, the remote UE, the relay UE, or both may be configured with a QoS table for use in determining the QoS parameters. However, a QoS table may be configured for sidelink communications (e.g., PQI) and a separate QoS table may be configured for Uu communications (e.g., 5QI), where the two different tables may not be correlated. Accordingly, the same information transmitted from the remote UE to the relay UE and then from the relay UE to the base station (or vice versa) may not be associated with correlated QoS parameters.

To improve reliability and quality of communications at a remote UE, sidelink QoS parameters may be mapped to Uu QoS parameters so that the QoS parameters associated with remote UE can be unified across the sidelink and Uu link. In some cases, the mapping may map 5QI parameters to corresponding PQI parameters. Accordingly, based on one or more 5QI parameters, the remote UE, the relay UE, or both, may determine one or more PQI parameters based on the mapping and the one or more 5QI parameters. In some other cases, the mapping may map Uu priorities to sidelink (e.g., PC5) priorities. Accordingly, the remote UE, the relay UE, the base station, or a combination thereof may be unable to determine appropriate sidelink QoS parameters to maintain an E2E QoS.

In some cases, devices (e.g., remote UE, relay UE, base station) may be preconfigured with the mappings (e.g., a default mapping). In some cases, a base station may determine a mapping for communications with a particular UE (e.g., dedicated mapping, UE-specific mapping), where the base station may indicate the mapping to the corresponding relay UE and corresponding remote UE. Additionally, the base station, relay UE, remote UE, or a combination thereof may be configured with Uu link parameters associated with the Uu link between the relay UE and the base station. The base station, the remote UE, and the relay UE may thus determine one or more sidelink parameters to use for communications between the remote UE and the relay UE based on the mapping and the one or more Uu link parameters. Accordingly, the sidelink parameters and Uu link parameters may be correlated so as to maintain a level of QoS for the remote UE across the sidelink and Uu link.

In some implementations, to further improve QoS maintenance, such as E2E QoS maintenance, a remote UE or a relay UE may be configured to transmit information to the base station. For example, overall E2N QoS may be based on the sidelink QoS and Uu QoS. However, in some cases, such as in mode 1 resource allocation, a relay UE may request resources from the base station for establishing a sidelink connection with a remote UE, where the request may indicate the remote UE and a QoS associated with the remote UE. However, the QoS may not provide the base station with enough information for configuring resources to accommodate the indicated QoS because the base station may be unable to determine whether the indicated QoS is a Uu QoS or a E2E QoS. Accordingly, the relay UE, the remote UE, or both may be configured to indicate additional information to the base station to enable the base station to configure appropriate resources to maintain an E2E QoS between the base station and remote UE (via the relay UE). For example, the remote UE, the relay UE, or both may indicate an E2E bearer identifier (e.g., UE E2E bearer ID), QoS profile information (e.g., PC5 QoS profile information), remote UE identifier, remote UE bearer identifier, etc. Accordingly, the base station may determine sidelink QoS channel information, or sidelink resources for the remote UE that supports the E2E QoS.

Particular aspects of the subject matter described herein may be implemented to realize one or more advantages. The described techniques may support improvements in communications between a remote UE and base station via a relay UE by unifying QoS parameters across different link types to improve reliability, and resource coordination between devices, among other advantages. As such, supported techniques may include improved network operations and, in some examples, may promote network efficiencies, among other benefits.

Aspects of the disclosure are initially described in the context of wireless communications systems. Aspects are the described with reference to process flows, and QoS parameters tables. Aspects of the disclosure are further illustrated by and described with reference to apparatus diagrams, system diagrams, and flowcharts that relate to techniques for performing QoS management for sidelink communications.

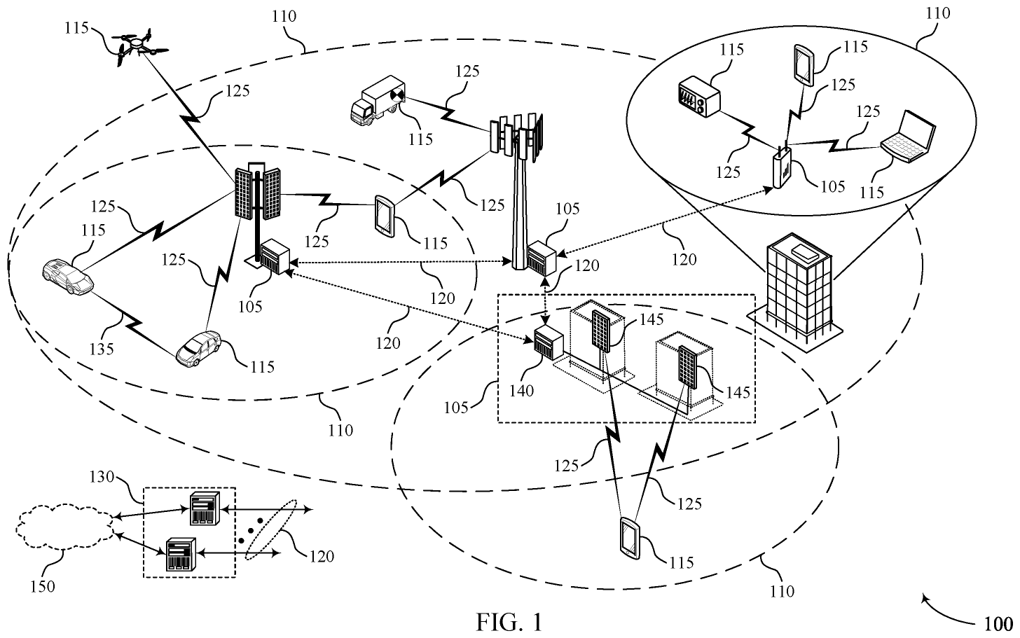

FIG. 1 illustrates an example of a wireless communications system 100 that supports techniques for performing QoS management for sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, network entity, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The described techniques provide for improved methods of establishing a connection for a remote UE 115 while maintaining a QoS. For example, the improved methods may include a remote UE 115 establishing a first connection with a relay UE 115 that is in communication with a base station 105 via a second connection. The first connection may be of a first connection type (e.g., sidelink communication type, PC5 communication type) and the second connection may be of a second connection type (e.g., Uu communication type). The remote UE 115 may identify a mapping between one or more first QoS parameters corresponding to the first connection type and one or more second QoS parameters corresponding to the second connection type. The remote UE 115 may determine, using the mapping, a first QoS parameter to be applied to the first connection as part of an E2E connection with the base station 105 via the relay UE 115, and communicate with the base station 105 via the relay UE 115 using the E2E connection.

From the perspective of the relay UE 115, the improved methods may include the relay UE 115 establishing a first connection with a remote UE 115, where the relay UE 115 may be in communication with a base station 105 via a second connection. The first connection may be of a first connection type (e.g., sidelink communication type, PC5 communication type) and the second connection may be of a second connection type (e.g., Uu communication type). The relay UE 115 may identify a mapping between one or more first QoS parameters corresponding to the first connection type and one or more second QoS parameters corresponding to the second connection type. The relay UE 115 may determine, using the mapping, a first QoS parameter to be applied to the first connection as part of an end-to-end connection between the base station 105 and remote UE 115 via the relay UE 115. The relay UE 115 may relay communications between the base station 105 and the remote UE 115 using the end-to-end connection.

In some cases, the improved methods may include a network device (e.g., base station 105, node) establishing an E2E connection with a remote UE 115 via a relay UE 115, where the E2E connection may include a first connection and a second connection. The network device may be in communication with the relay UE 115 via the second connection and the relay UE 115 may be in communication with the remote UE 115 via the first connection, where the first connection may be of a first connection type (e.g., sidelink communication type, PC5 communication type, Wi-Fi, Bluetooth, device-to-device, peer-to-peer) and the second connection being of a second connection type (e.g., Uu communication type). The network device may identify a mapping between one or more first QoS parameters corresponding to the first connection type and one or more second QoS parameters corresponding to the second connection type, and communicate with the remote UE 115 via the relay UE 115 using the end-to-end connection.

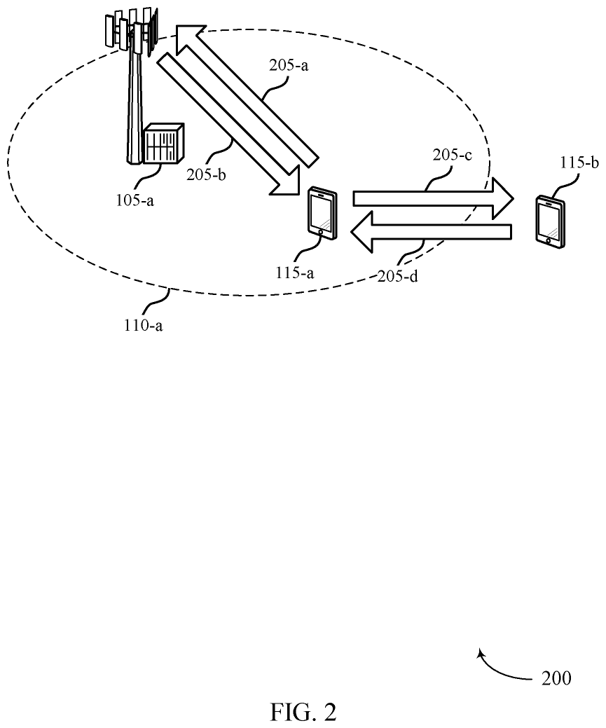

FIG. 2 illustrates an example of a wireless communications system 200 that supports techniques for performing QoS management for sidelink communications in accordance with aspects of the present disclosure. The wireless communications system 200 may include base station 105-a and UEs 115-a, and 115-b, which may be examples of a base station 105 and UEs 115 as described with reference to FIG. 1. Base station 105-a may serve a geographic coverage area 110-a. In some cases, UE 115-a, UE 115-b, or both may be configured to determine one or more sidelink parameters to support communications between UE 115-aand UE 115-b. Additionally or alternatively, other wireless devices, such as base station 105-a, may be configured to determine the one or more sidelink parameters.

In some implementations, a UE 115 such as UE 115-b may establish a connection with a base station 105, such as base station 105-a, via another UE 115, such as UE 115-a. For example, in some cases, UE 115-b (e.g., a remote UE 115) may be out-of-coverage of base station 105-a (e.g., outside geographic coverage area 110-a), but may be near UE 115-a (e.g., within a certain distance). In some cases, UE 115-a may be within geographic coverage area 110-a of base station 105-a and may have an established connection with the base station 105. For example, UE 115-a and base station 105-a may have established a connection, such as by performing a random access channel procedure, and the two devices may communicate accordingly. UE 115-a may transmit one or more signals (e.g., control signal, data signal, some other signal) to base station 105-a via communications link 205-a (e.g., a Uu link) and base station 105-a may transmit one or more signals (e.g., control signal, data signal, some other signal) to UE 115-a via communications link 205-a.

As UE 115-b is outside geographic coverage area 110-a, to establish a connection with base station 105-a, UE 115-b may establish a sidelink connection with UE 115-a (e.g., a relay UE). Accordingly, UE 115-a may relay communications between UE 115-b and base station 105-a. For example, upon establishing sidelink connection, UE 115-a may transmit one or more signals (e.g., control signal, data signal, some other signal) to UE 115-b via communications link 205-c (e.g., a sidelink communications link 205) and UE 115-b may transmit one or more signals (e.g., control signal, data signal, some other signal) to UE 115-a via communications link 205-d (e.g., a sidelink communications link 205).

In some cases, UE 115-a, UE 115-b, or both may be configured with Qos parameters (e.g., priorities, modulation and coding scheme (MCS), packet error rate) for maintaining QoS associated with at least communications for UE 115-b. In some cases, UE 115-a, UE 115-b, or both may be configured with one or more QoS tables for use in determining the QoS parameters. For example, a QoS table may be configured for sidelink communications (e.g., a PQI QOS table) and a separate QoS table may be configured for Uu communications (e.g., a 5QI QoS table). 5QI may refer to a set of parameters that control QoS for a particular link, such as a Uu link, and PQI may refer to a set of parameters that control QoS over a sidelink (e.g., PC5 interface). Accordingly, the 5QI table may be used to determine QoS parameters for use between UE 115-a and base station 105-a and the PQI table may be used to determine QoS parameters for use between UE 115-a and UE 115-b.

The QoS associated with UE 115-b may thus be split, such that E2N QoS of UE 115-b is based on the sidelink QoS and Uu link QoS. However, the 5QI table and the PQI table may not be correlated. Accordingly, UE 115-a, UE 115-b, base station 105-a, or a combination thereof may be unable to determine appropriate sidelink QoS parameters to maintain the E2E QOS based on Uu link QoS parameters. For example, UE 115-a, UE 115-b, base station 105-a, or a combination thereof may be configured with a set QoS parameters associated with Uu link between UE 115-a and base station 105-a, but the devices may be unable to reliably determine which QoS parameters to use for the sidelink between UE 115-aand UE 115-b to satisfy the E2E QoS.

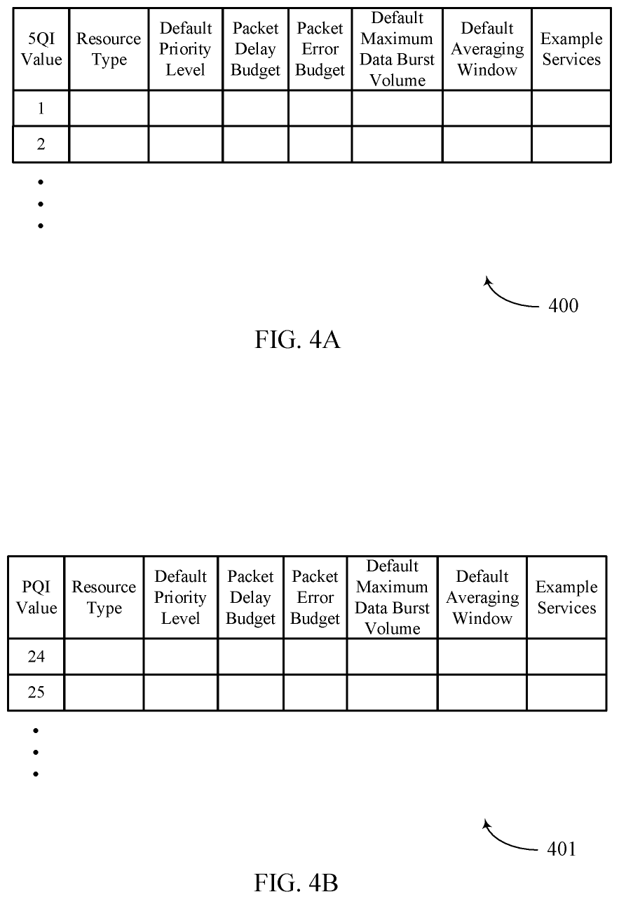

To improve reliability and quality of communications at a remote UE 115, sidelink QoS parameters (e.g., PQI) may be mapped to Uu QoS parameters (e.g., 5QI) so that the QoS parameters associated with remote UE 115 can be unified across the sidelink and Uu link, and thus the E2E QoS of the remote UE 115 may be achieved. In some cases, the mapping may map 5QI parameters to corresponding PQI parameters (as described in more detail with reference to FIGS. 4A and 4B). Accordingly, based on one or more 5QI parameters, the remote UE 115, the relay UE 115, or both, may determine one or more PQI parameters based on the mapping and the one or more 5QI parameters. In some other cases, the mapping may map Uu priorities to sidelink (e.g., PC5) priorities (as described in more detail with reference to FIGS. 4A and 4B). Accordingly, the remote UE 115, the relay UE 115, or both may be configured with a Uu priority, and the remote UE 115, the relay UE 115, or both may determine a sidelink priority based on the sidelink priority being mapped to the Uu priority.

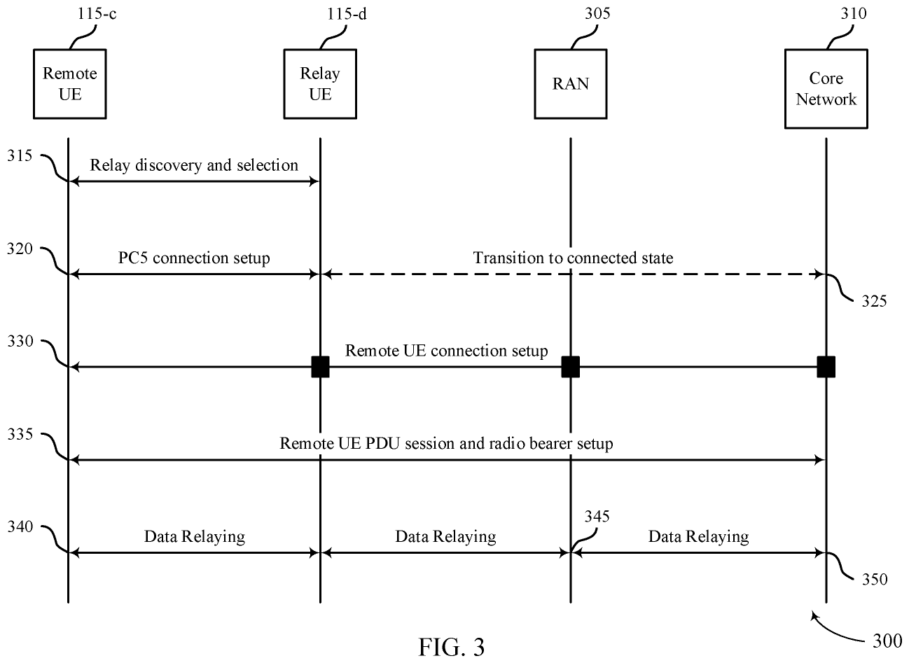

FIG. 3 illustrates an example of a process flow 300 that supports techniques for performing QoS management for sidelink communications in accordance with aspects of the present disclosure. The process flow 300 may be performed by a base station, remote UE 115-c, and a relay UE 115-d, which may be examples of a base station 105 and UEs 115 as described with reference to FIGS. 1 and 2. In some cases, radio access network (RAN) 305 (e.g., a 5G RAN) may be referred to as a base station, or a combination of the RAN 305 and a core network 310 (e.g., 5G core network) may be referred to as a base station. In some cases, the remote UE 115, the relay UE 115, or both may be configured to determine one or more sidelink parameters to support communications between the remote UE 115 and the relay UE 115. Additionally or alternatively, other wireless devices, such as a base station, may be configured to determine the one or more sidelink parameters. Alternative examples of the following may be implemented, where some steps are performed in a different order than described or are not performed at all. In some cases, steps may include additional features not mentioned below, or further steps may be added.

In some implementations, a UE 115 may detect another UE 115 and determine to connect with the other UE 115. In some cases, the UE 115 may determine to connect with the other UE 115 to gain access to the RAN 305 serving the other UE 115. For example, the UE 115 may be a remote UE 115 in which the remote UE 115 may be outside the coverage area served by the RAN 305. Therefore, the remote UE 115 may not be able to establish a direct connection with the RAN 305, but instead, may be able to establish a connection with the core network 310 via the other UE 115 (e.g., relay UE 115), where the remote UE 115 may be able to communicate with the RAN 305 and the core network 310 via the relay UE 115. In some cases, the remote UE 115 may establish a connection with a relay UE 115 in accordance with a layer 2 architecture. In some cases, the remote UE 115-c (e.g., layer 2 remote UE 115-c) may establish a connection with the RAN 305 and/or the core network 310 via relay UE 115-d (e.g., a 5G AS and/or NAS connection).

In an example of establishing a connection between remote UE 115-c and relay UE 115-d, at 315, remote UE 115-c and relay UE 115-d may perform relay discovery and selection. During such as procedure remote UE 115-c may detect UE 115-d, such as via one or more signals being transmitted by relay UE 115-d, or via some other method. Relay UE 115-d may similarly detect remote UE 115-c. If remote UE 115-c detects multiple other UEs 115 (e.g., multiple potential relay UEs 115), then UE 115-c may select one or more of the relay UEs 115 to establish a connection with based on one or more parameters (e.g., distance, load). For example, remote UE 115-c may select relay UE 115-d.

At 320, remote UE 115-c and relay UE 115-c may perform PC5 connection setup to establish the PC5 interface (e.g., sidelink) between remote UE 115-c and relay UE 115-c. Remote UE 115-c and relay UE 115-d may establish a PC5 unicast link. In some cases, during the PC5 connection setup, relay UE 115-d may be in a non-connected state with the RAN 305. For example, relay UE 115-d may be in a radio resource control (RRC) idle, or RRC inactive mode in relation to the Uu link between relay UE 115-d and the RAN 305. Accordingly, to be able to relay communications between remote UE 115-c and the RAN 305, at 325, relay UE 115-c may transition to a connected state (e.g., an RRC active, an RRC connected state) with regard to the Uu link between relay UE 115-d and the RAN 305. To transition to a connected state, relay UE 115-d may communicate with the core network 310, where relay UE 115-c may request or otherwise indicate that relay UE 115-c is transitioning to a connected state.

In some cases, such as if remote UE 115-c and relay UE 115-d established a layer 2 connection, then remote UE 115-c may establish a connection with the core network 310 to support the traffic of remote UE 115-c. For example, remote UE 115-c may establish a Uu connection with the core network 310. Accordingly, at 330, remote UE 115-c may perform connection setup with the core network 310 via relay UE 115-d, and RAN 305. For example, during the connection setup procedure, remote UE 115-c may transmit one or more messages (e.g., NAS messages, RRC messages) to relay UE 115-d, relay UE 115-d may relay the messages to the RAN 305, and the RAN 305 may relay the messages to the core network 310. At 335, upon establishing a connection with the core network 310, the remote UE 115-c may setup a protocol data unit (PDU) session and a radio bearer (e.g., dedicated radio bearer) with the core network 310. The RAN 305 may configured one or more radio bearers for remote UE 115-c. In some cases, due to the layer 2 architecture of the connection, relay UE 115-c may not be configured with a service data adaptation protocol (SDAP) and packet data convergence protocol (PDCP) for the remote UE 115-c. Rather, the SDAP and PDCP for the remote UE 115-c may be terminated at the remote UE 115-c and the RAN 305. Accordingly, remote UE 115 may communicate via a PC5 channel with relay UE 115-d (e.g., a PC5 radio link control (RLC) channel, which may be referred to as a PC5 RLC bearer, and may refer to PC5 RLC medium access control (MAC), or physical layer of the remote UE 115-c) and the relay UE 115-d may then relay the communication via a Uu channel to the RAN 305 (e.g., via a Uu RLC channel, which may be referred to as a Uu RLC bearer, and may refer to a Uu RLC MAC, or physical layer of the relay UE 115-d). The Uu link between the relay UE 115-d and the RAN 305 may have been an established Uu connection between relay UE 115-d and the RAN 305 prior to remote UE 115-c requesting a connection. However, to support the relaying (e.g., Layer 2 relaying) for remote UE 115-c, the Uu connection may be configured to support additional bearers so that the Uu link may support E2N QoS enforcement between the remote UE 115-c and the core network 310.

When the PDU session and radio bearer are established, the remote UE 115-c may communicate (e.g., transmit, receive) data with the core network (e.g., layer 2 relaying). For example, at 340, remote UE 115-c may transmit data intended for the core network 310 to relay UE 115-c. Accordingly, at 345, relay UE 155-d may relay the data to the RAN 305, and at 350, the RAN may relay the data to the core network 310. The core network 310 may transmit data to remote UE 115-c in a similar manner.

In some implementations, the RAN 305 may perform QoS management and enforcement for the PC5 interface, the Uu interface, or both, associated with remote UE 115-c. For remote UE 115-c accessing the core network 310 via layer 2 (e.g., Layer-2 UE-to-Network Relay), the existing QoS control (e.g., 5G QoS control) may be reused between the remote UE 115-c and the core network of the remote UE 115-c. The session management function (SMF) of the remote UE 115-c may provide QoS profiles to the RAN 305. In some cases, the RAN 305 may handle the QoS breakdown (e.g., QoS split) of the Uu interface and PC5 interface for the E2N QoS enforcement of a session established between remote UE 115-c and the core network 310, such as in the case of layer 2 relaying between remote UE 115-c and the core network 310.

With regard to the Uu connection between relay UE 115-d and the RAN 305, the relay UE 115-d and the RAN 305 may perform a Uu QoS setup procedure (e.g., prior to remote UE 115-c requesting connection). During the Uu QoS setup procedure, the relay UE 115-d and the RAN 305 may establish a PDU session. In some cases, the RAN 305 may receive a QoS flow and QoS parameters (e.g., 5QI, GMBR, MFBR) from an AMF during the PDU session setup or modification. The relay UE 115-c may receive an indication of the QoS information (e.g., QoS flow, QoS parameters) during the PDU session setup. In some cases, the RAN 305 may transmit the Uu radio bearer (e.g., dedicated radio bearer) configuration (e.g., the Uu logical channel priority, bit rates) to the relay UE 115-d in an RRC reconfiguration message. In some cases, the RAN 305 may transmit a PDU session establishment accept message to relay UE 115-d that may include the QoS information (e.g., 5QI).

As remote UE 115-c may be considered behind relay UE 115-d in regard to the RAN 305, there is an additional hop from relay UE 115-d to remote UE 115-c, where the additional hop may refer to the PC5 interface between relay UE 115-d and remote UE 115-c. In some cases, as described, the sidelink radio bearers may be configured by the RAN 305 (e.g., network configured via system information block (SIB) 12 (e.g., SIB12) or a dedicated RRC message). In some other cases, the sidelink radio bearers may be preconfigured. In some cases, the RAN 305 may transmit the RRC reconfiguration to the relay UE 115-d (e.g., the RRC connected UE 115), and the relay UE 115-d may relay the RRC reconfiguration to remote UE 115-c. In some cases, if remote UE 115-c and relay UE 115-d establish a sidelink unicast link, the remote UE 115-c and relay UE 115-d may negotiate sidelink radio bearer parameters related to both transmission and reception between the UEs 115. If one or more of the sidelink radio bearer petameters are related to transmission only, then the UEs may not negotiate such parameters.

The Uu link between relay UE 115-d and the RAN may be associated with 5QI, which may have been established during a PDU session establishment procedure. Similarly, the PC5 link between remote UE 115-c and relay UE 115-d may be associated with PQI to maintain QoS of the PC5 link. In some cases, to maintain an E2E QOS for the remote UE 115-c, the PQI and 5QI may be correlated so that the QoS of the PC5 link and the QoS of the Uu link may result in the overall E2E QoS.

FIGS. 4A and 4B illustrate examples of QoS parameter tables 400 and 401, respectively, that support techniques for performing QoS management for sidelink communications in accordance with aspects of the present disclosure. The QoS parameter tables 400 and 401 may be used by a base station, remote UE, and/or a relay UE, which may be examples of a base station 105 and UEs 115 as described with reference to FIGS. 1 through 3. In some cases, the remote UE 115, the relay UE 115, or both may be configured to determine one or more sidelink parameters, such as QoS parameters, to support communications between the remote UE 115 and the relay UE 115. Additionally or alternatively, other wireless devices, such as a base station, may be configured to determine the one or more sidelink parameters.

As described herein, a remote UE 115 may establish a layer 2 PC5 connection with a relay UE, where the relay UE may relay communications between the remote UE and a RAN via a Uu connection. The PC5 connection may be associated with PQI for maintaining the QoS of the link and the Uu connection may be associated with 5QI for maintaining QoS of the link. In some cases, the PQI that is associated with a PC5 link may be selected from a PQI table and the 5QI that is associated with a Uu link may be selected from a 5QI table. FIG. 4A may depict an example 5QI table and FIG. 4B may depict an example PQI table.

The example 5QI table depicted by FIG. 4A may include a plurality of 5QI values, resource types, default priority levels, packet delay budgets, packet error budgets, default maximum data burst volumes, default averaging windows, examples services, etc. In some cases, the 5QI value may be selected based on an example service. For example, the 5QI value may be associated with a set of parameters to maintain a QoS for the example service. For example, a 5QI value of 1 may be associated with default priority level of 20 for conversational voice service, but a 5QI value of 65 may be associated with a default priority level of 7 for mission critical communications (e.g., mission critical user plane push-to-talk voice (MCPTT)).

Similarly, the PQI table depicted in FIG. 4B may include a plurality of PQI values, resource types, default priority levels, packet delay budgets, packet error budgets, default maximum data burst volumes, default averaging windows, examples services, etc. In some cases, the PQI value may be selected based on an example service. For example, the PQI value may be associated with a set of parameters to maintain a QoS for the example service. For example, a PQI value of 24 may be associated with default priority level of 1 for mission critical communications (e.g., mission critical user plane push-to-talk voice (MCPTT)). Therefore, an MCPTT service may be associated with a PQI priority of 1 but a 5QI priority of 7. As depicted, the corresponding PQI and 5QI values for a particular service may be different (e.g., a PQI value of 1 (on a scale of 1 to 6) and 5QI value of 65 (on a scale of 1 to 66) may both map to MCPTT). Additionally, PQI priority levels may include a scale of 1 to 6 and 5QI priority values may include a scale of 7 to 50, for example. Further, one or more other parameters, such as a packet delay budget, between 5QI and PQI for the same service may be different for the same service. Therefore, for the same service, a Uu link and a PC5 may each be associated with a set of QoS parameters for maintaining QoS. However, the set of QoS parameters may differ for each link and the QoS parameters may be uncorrelated. As such, two different links associated with the same E2E connection may be unrelated, and may result in potential unreliable QoS.

To ensure that a remote UE receives unified QoS across the Uu and PC5 interfaces to achieve an E2E QoS, Uu parameters may be mapped (e.g., correlated) to PC5 parameters (e.g., QoS mapping). Accordingly, the PC5 link and Uu link of an E2E connection between a remote UE and a core network may maintain the QoS. In some cases, the mapping may map 5QI parameters to corresponding PQI parameters. For example, PQI values may be mapped to 5QI values. Therefore, a 5QI value associated with a Uu link of the E2E connection may be compared to the table, and the corresponding PQI value may be determined based on the mapping. In such cases, multiple PQI parameters for the PC5 of the E2E connection may be determined from the mapping because the multiple PQI parameters may be associated with the determined PQI value. For example, 5QI value 64 may be mapped to PQI value 24. Accordingly, the PQI value may be determined based on the 5QI value and the QoS mapping. The remaining PQI parameters may also be determined based on the PQI value.

In some other cases, the mapping may map Uu priorities to PC5 priorities. Therefore, upon determining a Uu priority associated with a Uu link of the E2E connection, a corresponding PC5 priority may be determined for the PC5 link of the E2E connection based on the mapping. In some cases, other PC5 parameters may be determined based on the determined PC5 priority. For example, based on a PQI table (as depicted by FIG. 4B), the one or more other PQI parameters associated with the determined PC5 priority may be determined. In some other cases, the one or more other PQI parameters may be separately indicated. In some implementations, the mapping may map any PC5 and Uu parameters, such as resource types, packet delay budgets, packet error rates, averaging windows, data burst values, etc. such that upon determining one or more 5QI parameters for a Uu link of the E2E connection, the PQI parameters for the PC5 link of the E2E connection may be determined. For example, 5QI priority 7 may be mapped to PQI priority 1. Accordingly, the PQI priority may be determined based on the 5QI priority. However, the other PQI parameters may not be assumed based on the determined PQI priority. In some cases, the mapping may be indicated in a table.

In some cases, QoS mapping may configured as default QoS mapping that may apply to multiple UEs (e.g., all UEs communicating with the core network, or all UEs communicating with a RAN). Accordingly, each of the multiple UEs may receive an indication or be pre-configured with the default QoS mapping. In some cases, QoS mapping may be configured as dedicated QoS mapping in which the dedicated QoS mapping may be configured for a particular remote UE 115. Accordingly, each UE may receive an indication or be preconfigured with a dedicated QoS mapping for each respective UE. In some cases, a core network and/or RAN may use a combination of the default QoS mapping and the dedicated QoS mapping. For example, a core network may configure a set of UEs served by the core network to use the dedicated QoS mapping, and the remaining UEs served by the core network may use the default QoS mapping.

A RAN, a remote UE, and/or a relay UE associated with an E2E service may be configured with the QoS mapping (e.g., default and/or dedicated) aperiodically, semi-statically, or dynamically. For example, the QoS mapping may change and the devices may receive an indication of the updated mapping accordingly. In some cases, the RAN may determine the PQI based on the mapping and indicate the PQI to the relay UE, and to the remote UE (via the relay UE). In some cases, the relay UE may determine the PQI based on the mapping and indicate the PQI to the remote UE, the RAN, or both. In some cases, the remote UE may determine the PQI based on the mapping and indicate the PQI to the relay UE, the RAN, or both. In some cases, each device (e.g., the RAN, the remote UE, the relay UE) may be configured to determine the PQI for the PC5 link between the remote UE and the relay UE for the E2E connection associated with the remote UE. In some cases, the core network, or an operator of the devices may determine the QoS mapping (e.g., dedicated or default).

In some implementations, a remote UE and a relay UE associated with an E2E connection may be provisioned with the default QoS mapping information through pre-configuration or the relay UE may receive an indication of the default QoS mapping and may relay the mapping information to the remote UE via a SIB or RRC message (e.g., a dedicated RRC message). In some implementations, the relay UE and the remote UE may be provisioned with the dedicated QoS mapping information (for L2 relaying) during a proximity service (ProSe) Policy provisioning procedure performed by the policy control function (PCF) of the core network or during the PDU session establishment or modification procedures.

In some implementations, a remote UE can be configured with the PC5 link configuration to satisfy the E2E QoS. For example, the remote UE may receive (e.g., from the relay UE) or otherwise identify the 5QI of E2E dedicated radio bearer and determine the PQI (e.g., the PC5 RLC bearer) parameters using the 5QI to PQI QOS mapping information. In another example, the relay UE may transmit, to the remote UE, the PC5 channel configuration (e.g., logical channel configuration, where the PC5 logical channel configuration may be the PQI, or may indicate the PQI of the PC5 channel. The relay UE may determine or receive an indication, such as from the RAN, of the PC5 channel configuration, and the relay UE may relay the PC5 channel configuration to the remote UE. The PC5 channel configuration may include priority, prioritized bit rates, one or more other parameters, or a combination thereof to satisfy the E2E QoS. The relay UE may transmit the PC5 channel configuration to the remote UE in an RRC message, such as an RRC sidelink reconfiguration message (e.g., RRCReconfigurationsidelink message).

In some implementations, a relay UE can be configured with the PC5 link configuration (e.g., the PC5 RLC bearer configuration) associated with a remote UE to satisfy the E2E QOS for the remote UE. For example, the RAN or the remote UE may transmit a 5QI value corresponding to the remote UE E2E radio bearer (e.g., dedicated radio bearer). The RAN may include the 5QI value in an RRC message, such as an RRC reconfiguration message, where the RRC reconfiguration may be transmitted to the relay UE for configuring the relaying Uu link (e.g., Uu RLC channel) configuration. The remote UE may include the 5QI value in an RRC sidelink reconfiguration message (e.g., RRCReconfigurationsidelink) or a PC5-S link modification message. Accordingly, the relay UE may determine the parameters for the PC5 link (e.g., PC5 RLC channel) based on 5QI to PQI mapping information. In another example, the remote UE may determine the PQI (e.g., PC5 logical channel configuration) and transmit an indication of the channel configuration to the relay UE, where the indication may include priority, prioritized bit rates, one or more other parameters, or a combination thereof to satisfy E2E QoS. The relay UE may receive the indication in an RRC message, such as an RRC sidelink reconfiguration message (e.g., RRCReconfigurationsidelink message).

A remote UE and a relay UE may configure the PC5 link parameters (e.g., PC5 RLC channels such as RLC, MAC, physical layer) using an RRC sidelink reconfiguration message (e.g., RRCReconfigurationsidelink). As the RRC sidelink reconfiguration message may not be used to exchange the transmitting only or receiving only parameters such as logical channel priority, bit rates, etc., then the remote UE and the relay UE may determine such parameters on their own from the mapping information or changes indicated in the RRC sidelink reconfiguration message.

In some implementations, the RAN associated with an E2E connection may be provisioned with a default QoS mapping information through local configuration (e.g., from the core network). In some implementations, the RAN may be provisioned with a dedicated QoS mapping for a remote UE or a particular E2E connection. For example, an AMF may provision the RAN with the QoS mapping (e.g., default or dedicated). In some cases, the RAN may receive the QoS mapping from the AMF during UE Policy Association Establishment procedure, a UE Policy Association Modification procedure, or both. In some cases, the RAN may receive the QoS mapping from the AMF during a UE PDU session establishment, a PDU session modification procedure, or both. In some implementations, an SMF (e.g., of the core network) may transmit the QoS mapping information to AMF (e.g., in Namf_Communication_NIN2MessageTransfer, for example). In some implementations, the AMF may transmit the QoS mapping to the RAN in a NAS message (e.g., an N2 PDU Session Request). In some cases, the N2 SM information included in the NAS message (e.g., the N2 PDU Session Request, PDU Session Establishment Accept) such as a PDU Session ID, N1 SM container, core network assisted RAN parameters tuning, may include the QoS mapping information.

In some implementations, a RAN may be configured to split the E2E QoS into PC5 QoS and Uu QoS. In some cases, the Uu link (e.g., Uu RLC channel) priority may be based on the 5QI of the remote UE E2E bearer. In some cases, the PC5 link (e.g., PC5 RLC channel) priority may be based on the QoS mapping information. If there is no entry matching the 5QI, however, then the PC5 priority may be set to priority based on implementation set values. Parameters for Uu and PC5 entities (e.g., RLC, MAC, physical layer entities) may be set to satisfy the remote UE 5QI needs. In some cases, other QoS parameters such as maximum flow bit rate, guaranteed maximum bitrate (GMBR), packet delay budget, packet error rate etc.) may be set to satisfy the remote UE 5QI needs by the RAN. In some cases, the remote UE may transmit to the relay UE the E2E QoS parameters for the remote UE bearer and the relay UE may use the E2E QOS parameters to determine the QoS for the PC5 RLC channels.

In some implementations, access stratum parameters to use for a sidelink radio bearer (e.g., sidelink dedicated radio bearer) may be determined by a transmitting/receiving UE based on the QoS flow mapping and the configuration. However, as there may not be a sidelink SDAP, and PDCP, and QoS parameters may not be provided from V2X layer to the access stratum layer, the core network may provide PC5 link parameters (e.g., PC5 RLC channel configuration) to the remote UE, the relay UE, or both. Additionally or alternatively, the remote UE, the relay UE, or both may be configured to determine the configuration parameters based on the QoS mapping information.

In some implementations, a relay UE, or a remote UE, or both may perform mode 1 resource allocation in which the RAN may configure and indicate the resources to the respective UEs. For example, such as in mode 1 resource allocation, a relay UE may request resources from the base station for establishing a sidelink connection with a remote UE, where the request may indicate the remote UE and a QoS associated with the remote UE. However, the QoS may not provide the base station with enough information for configuring resources to accommodate the indicated QoS because the base station may be unable to determine whether the indicated QoS is a Uu QoS or a E2E QoS. For example, when the relay operates in mode 1 resource allocation, an RRC message (e.g., an RRCReconfiguration message) may not be able to configure a sidelink bearer to enforce E2E QoS because a PC5 SDAP and PC5 PDCP of the remote UE may not be configured (due to a layer 2 connection). Additionally or alternatively, an RRC message (e.g., an RRCReconfiguration message) may not be able to configure a sidelink bearer to enforce E2E QoS because a QoS field list (e.g., QoS field sl-QoS-InfoList-r16) may not be relevant to the remote UE. Additionally or alternatively, an RRC message (e.g., an RRCReconfiguration message) may not be able to configure a sidelink bearer to enforce E2E QoS because a sidelink UE information (SUI) message (e.g., a SidelinkUEInformationNR message) may not be configured to indicate sufficient E2E QOS requirement information for L2 remote UE (e.g., to which the relay UE is connected).

Accordingly, to enforce E2E QoS of a remote UE, the relay UE, the remote UE, or both may be configured to indicate additional information to the RAN to enable the RAN to configure appropriate resources to maintain an E2E QOS between the core network and remote UE (via the relay UE). For example, the remote UE, the relay UE, or both may indicate an E2E bearer identifier (e.g., UE E2E bearer ID), QoS profile information (e.g., PC5 QoS profile information), remote UE identifier, remote UE bearer identifier, etc. Accordingly, the RAN may determine sidelink QoS channel information, or sidelink resources for the remote UE that supports the E2E QoS.

For example, if the remote UE is operating according to mode 1 resource allocation, then to inform the RAN of the E2E QOS parameters (e.g., requirements) the remote UE may indicate the E2E bearer ID of the remote UE. Based on the E2E bearer ID and QoS mapping, the RAN may determine the QoS of the PC5 link (e.g., PC5 RLC channel) to support the E2E QoS. In some cases, the remote UE may indicate the E2E bearer ID of the remote UE and PC5 QoS profile information, such as PQI information without a packet flow identifier (PFI). Accordingly, the RAN may determine the QoS of the PC5 link (e.g., PC5 RLC channel) based on the QoS mapping. In some cases, the remote UE may indicate a relay UE ID and PC5 RSRP associated with relay UE to the RAN.

In another example, of the relay UE is operating in accordance with mode 1, the relay UE may indicate information to the RAN. In some cases, the relay UE may indicate a remote UE ID and Remote UE bearer ID as part of the SUI to the RAN. Such information may aid the RAN in determining mode 1 resources for the PC5 interface to support E2E QoS for the remote UE. In some cases, the relay UE may report the PC5 RSRP of the link between remote UE and the relay UE to assist the RAN, where the PC5 RSRP may be a sidelink RSRP (SL-RSRP) or a sidelink discovery RSRP (SD-RSRP). The RAN may use the RSRP information to select mode 1 resources for the PC5 link.

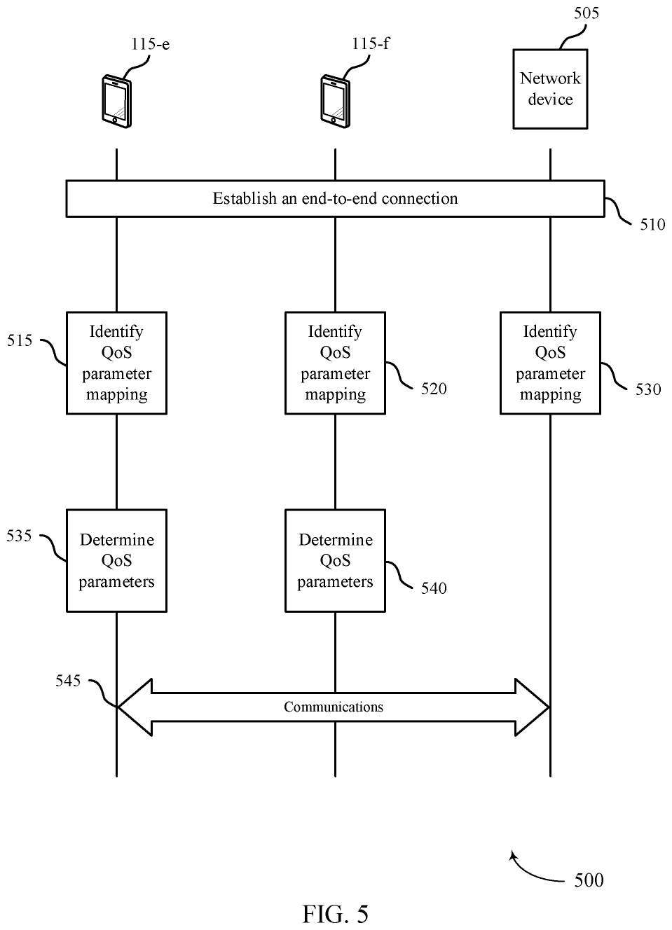

FIG. 5 illustrates an example of a process flow 500 that supports techniques for performing QoS management for sidelink communications in accordance with aspects of the present disclosure. The process flow 500 may illustrate an example QoS determination procedure. For example, network device 505 may perform a QoS determination procedure, where the QoS may be split across multiple different connection types. Network device 505 (e.g., network entity) may be an example of a base station described with reference to FIGS. 1 through 4B, or may be some other device (e.g., a node) or network function. UEs 115-e, and 115-f may be examples of the UEs 115 (e.g., wireless devices) described with reference to FIGS. 1 through 4B. UE 115-e may be example of a remote UE 115 and UE 115-f may be an example of a relay UE 115. In some cases, instead of network device 505 implementing the QOS determination procedure, a different type of wireless device (e.g., a UE 115) may perform a same or similar procedure. Alternative examples of the following may be implemented, where some steps are performed in a different order than described or are not performed at all. In some cases, steps may include additional features not mentioned below, or further steps may be added.

At 510, UE 115-e, UE 115-f, and network device 505 may establish a connection. For example, UE 115-e may establish a first connection with a relay UE that is in communication with a base station via a second connection. The first connection may be of a first connection type (e.g., sidelink communications type, PC5 communications type) and the second connection may be of a second connection type (e.g., Uu communications type).

At 515, UE 115-e may identify a mapping between one or more first QoS parameters corresponding to the first connection type and one or more second Qos parameters corresponding to the second connection type. In some cases, UE 115-e may receive an indication of the mapping between the one or more first QoS parameters corresponding to the first connection type and the one or more second QoS parameters corresponding to the second connection type. Receiving the indication of the mapping may include receiving the indication of the mapping during Proximity Services Policy provisioning by a Policy Control Function. Receiving the indication of the mapping may include receiving the indication of the mapping in a synchronization signal block, or a radio resource control message.

Identifying the mapping may include identifying that the mapping between the one or more first QoS parameters and the one or more second QoS parameters includes an association between 5QI table entries to PQI table entries. Identifying the mapping may include identifying that the mapping between the one or more first QoS parameters and the one or more second QoS parameters includes an association between second connection Qos flow priority values (e.g., Uu priority values) to first connection QoS flow priority values (e.g., sidelink priority values). Identifying the mapping may include identifying that the mapping is associated with UE 115-e in a UE-specific manner, or the mapping is associated with a plurality of remote UEs 115.

The one or more first QoS parameters, or the one or more second QoS parameters, or both may include a priority of the second connection type, a prioritized bitrate, a value associated with the second connection type, a resource type, a packet delay budget, a packet error rate, a data burst volume, an averaging window, or a combination thereof. In some cases, the one or more second QoS parameters may be based on a 5QI of an end-to-end radio bearer.

At 520, UE 115-f may identify a mapping between one or more first Qos parameters corresponding to the first connection type and one or more second QoS parameters corresponding to the second connection type. UE 15-f may receive an indication of the mapping between the one or more first QoS parameters corresponding to the first connection type and the one or more second QoS parameters corresponding to the second connection type. Receiving the indication of the mapping may include receiving the indication of the mapping during Proximity Services Policy provisioning by a Policy Control Function. Receiving the indication of the mapping may include receiving the indication of the mapping in a synchronization signal block, or a radio resource control message.

Identifying the mapping may include identifying that the mapping between the one or more first QoS parameters and the one or more second QoS parameters includes an association between 5QI table entries to PQI table entries. Identifying the mapping may include identifying that the mapping between the one or more first QoS parameters and the one or more second QoS parameters includes an association between second connection Qos flow priority values (e.g., Uu priority values) to first connection QOS flow priority values (e.g., sidelink priority values, PC5 priority values). Identifying the mapping may include identifying that the mapping is associated with UE 115-e in a UE-specific manner, or the mapping is associated with a plurality of remote UEs 115.

At 525, network device 505 may identify a mapping between one or more first QoS parameters corresponding to the first connection type and one or more second Qos parameters corresponding to the second connection type. Network device 505 may receive an indication of the mapping between the one or more first QoS parameters and the one or more second QoS parameters. Receiving the indication of the mapping may include receiving the indication of the mapping from an access and mobility management Function. Receiving the indication of the mapping may include receiving the indication of the mapping from a session management function via the access and mobility management Function. Receiving the indication of the mapping may include receiving the indication of the mapping during a UE Policy Association Establishment procedure, a UE Policy Association Modification procedure, or both.

At 530, UE 115-e may determine, using the mapping, a first QoS parameter to be applied to the first connection as part of an end-to-end connection with the network device 505 via UE 115-f. In some cases, UE 115-e may receive an indication of the one or more second QoS parameters corresponding to the second connection type. Determining the first QoS parameter to be applied to the first connection may be based on the indication. Receiving the indication may include receiving, from UE 115-f, a radio resource control reconfiguration message including the indication of the one or more second QoS parameters. Receiving the indication of the mapping may include receiving the indication of the mapping during a UE Protocol Data Unit session establishment procedure, a UE Protocol Data Unit session modification procedure, or both.

In some cases, network device 505 may determine a QoS split between the first connection and the second connection. Determining the QoS split may include determining the one or more second QoS parameters corresponding to the second connection type based on a 5QI configuration associated with an end-to-end bearer of UE 115-e.

In some cases, network device 505 may transmit, to UE 115-f, an indication of the one or more second QoS parameters corresponding to the second connection type. Transmitting the indication may include transmitting a radio resource control reconfiguration message including the indication of the one or more second QoS parameters.

In some cases, UE 115-e may transmit, to UE 115-e, an indication of the first QoS parameter to be applied to the first connection as part of the end-to-end connection with the base station via UE 115-f.

At 535, UE 115-f may determine, using the mapping, a first QoS parameter to be applied to the first connection as part of an end-to-end connection between the network device 505 and UE 115-e via UE 115-f. In some cases, UE 115-f may transmit, to UE 115-e, a first indication of the one or more first QoS parameters corresponding to the first connection type, a second indication of the one or more second QoS parameters corresponding to the second connection type, or both. Transmitting the first indication or the second indication may include transmitting, from UE 115-f, a radio resource control reconfiguration message including the first indication, the second indication, or both.

In some cases, UE 115-f may receive, from the network device 505, an indication of the one or more second QoS parameters corresponding to the second connection type, where determining the first QoS parameter to be applied to the first connection is based on the indication. Receiving the indication may include receiving a radio resource control reconfiguration message including the indication of the one or more second QoS parameters.

In some implementations, UE 115-e is operating in accordance with a resource allocation mode 1 when the first connection is a sidelink connection type. In such cases, UE 115-e may transmit an indication of an end-to-end bearer identifier associated with UE 115-e, the one or more first QoS parameters, an identifier of the relay UE, a reference signal received power associated with the first connection type, or a combination thereof. In some cases, UE 115-f may be operating in accordance with a random access mode 1 when the first connection is a sidelink connection type. Accordingly, UE 115-f may transmit an indication of a bearer identifier of UE 115-e, a reference signal received power associated with the first connection type, or a combination thereof. Network device 505 may determine mode 1 resources for the first connection based on the indication.

In some cases, UE 115-f may determine a first connection type bearer based on a second connection type bearer, and transmitting an indication of the second connection type bearer to UE 115-e via a radio resource control reconfiguration message. UE 115-f may utilize a first connection type bearer configuration for UE 115-e via a radio resource control reconfiguration message.

At 540, UE 115-e, UE 115-f, and network device 505 may communicate. For example, UE 115-e may communicate with network device 505 via the UE 115-f using the end-to-end connection. Accordingly, UE 115-f may relay communications between network device 505 and UE 115-e using the end-to-end connection.

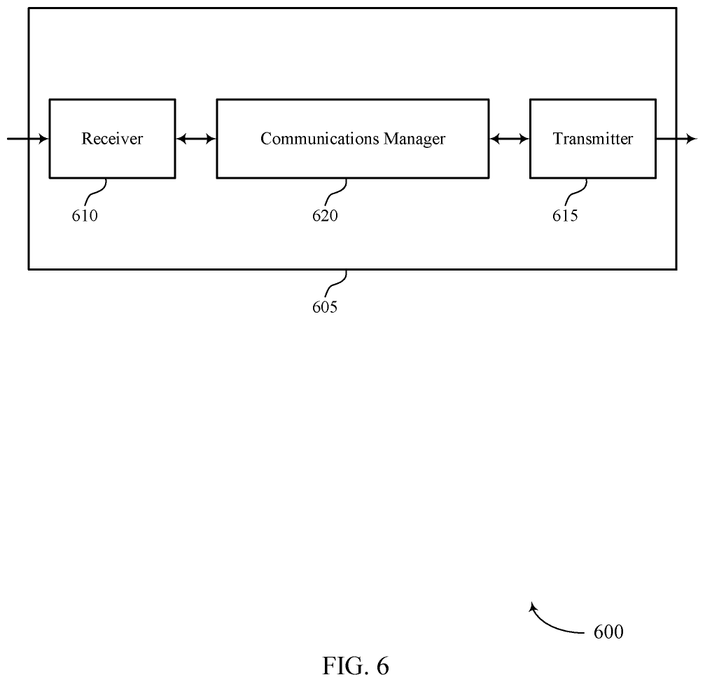

FIG. 6 shows a block diagram 600 of a device 605 that supports techniques for performing QoS management for sidelink communications in accordance with aspects of the present disclosure. The device 605 may be an example of aspects of a UE 115 (e.g., a wireless device) as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for performing QoS management for sidelink communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for performing QoS management for sidelink communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for performing QoS management for sidelink communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first wireless device in accordance with examples as disclosed herein. For example, the communications manager 620 may be configured as or otherwise support a means for establishing a first connection with a second wireless device that is in communication with a network entity via a second connection, where the first connection is of a first connection type and the second connection is of a second connection type. The communications manager 620 may be configured as or otherwise support a means for identifying a mapping between one or more first QoS parameters corresponding to the first connection type and one or more second QoS parameters corresponding to the second connection type. The communications manager 620 may be configured as or otherwise support a means for determining, using the mapping, a first QoS parameter to be applied to the first connection as part of an end-to-end connection with the network entity via the second wireless device. The communications manager 620 may be configured as or otherwise support a means for communicating with the network entity via the second wireless device using the end-to-end connection.

Additionally or alternatively, the communications manager 620 may support wireless communications at a first wireless device in accordance with examples as disclosed herein. For example, the communications manager 620 may be configured as or otherwise support a means for establishing a first connection with a second wireless device, where the first wireless device is in communication with a network entity via a second connection, the first connection is of a first connection type and the second connection is of a second connection type. The communications manager 620 may be configured as or otherwise support a means for identifying a mapping between one or more first QoS parameters corresponding to the first connection type and one or more second QoS parameters corresponding to the second connection type. The communications manager 620 may be configured as or otherwise support a means for determining, using the mapping, a first QoS parameter to be applied to the first connection as part of an end-to-end connection between the network entity and second wireless device via the first wireless device. The communications manager 620 may be configured as or otherwise support a means for relaying communications between the network entity and the second wireless device using the end-to-end connection.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, and more efficient utilization of communication resources.

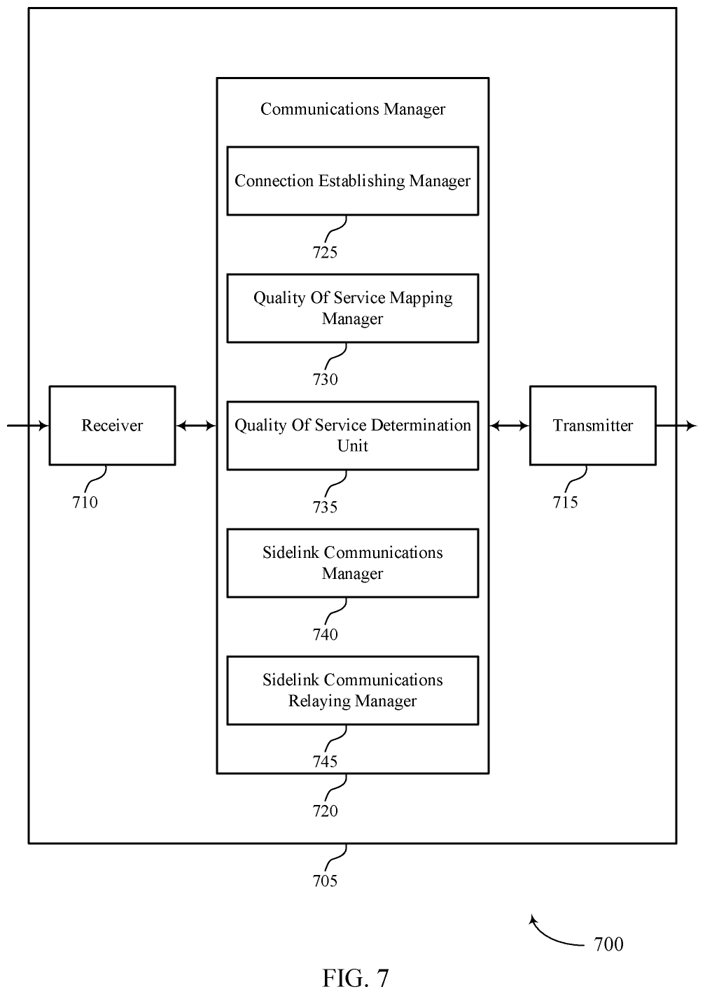

FIG. 7 shows a block diagram 700 of a device 705 that supports techniques for performing QoS management for sidelink communications in accordance with aspects of the present disclosure. The device 705 may be an example of aspects of a device 605 or a UE 115 (e.g., wireless device) as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for performing QoS management for sidelink communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for performing QoS management for sidelink communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for performing QoS management for sidelink communications as described herein. For example, the communications manager 720 may include a connection establishing manager 725, a QoS mapping manager 730, a QoS determination unit 735, a sidelink communications manager 740, a sidelink communications relaying manager 745, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a first wireless device in accordance with examples as disclosed herein. The connection establishing manager 725 may be configured as or otherwise support a means for establishing a first connection with a second wireless device that is in communication with a network entity via a second connection, where the first connection is of a first connection type and the second connection is of a second connection type. The QoS mapping manager 730 may be configured as or otherwise support a means for identifying a mapping between one or more first QoS parameters corresponding to the first connection type and one or more second QoS parameters corresponding to the second connection type. The QoS determination unit 735 may be configured as or otherwise support a means for determining, using the mapping, a first QoS parameter to be applied to the first connection as part of an end-to-end connection with the network entity via the second wireless device. The sidelink communications manager 740 may be configured as or otherwise support a means for communicating with the network entity via the second wireless device using the end-to-end connection.

Additionally or alternatively, the communications manager 720 may support wireless communications at a first wireless device in accordance with examples as disclosed herein. The connection establishing manager 725 may be configured as or otherwise support a means for establishing a first connection with a second wireless device, where the first wireless device is in communication with a network entity via a second connection, the first connection is of a first connection type and the second connection is of a second connection type. The QoS mapping manager 730 may be configured as or otherwise support a means for identifying a mapping between one or more first QoS parameters corresponding to the first connection type and one or more second QoS parameters corresponding to the second connection type. The QoS determination unit 735 may be configured as or otherwise support a means for determining, using the mapping, a first QoS parameter to be applied to the first connection as part of an end-to-end connection between the network entity and second wireless device via the first wireless device. The sidelink communications relaying manager 745 may be configured as or otherwise support a means for relaying communications between the network entity and the second wireless device using the end-to-end connection.

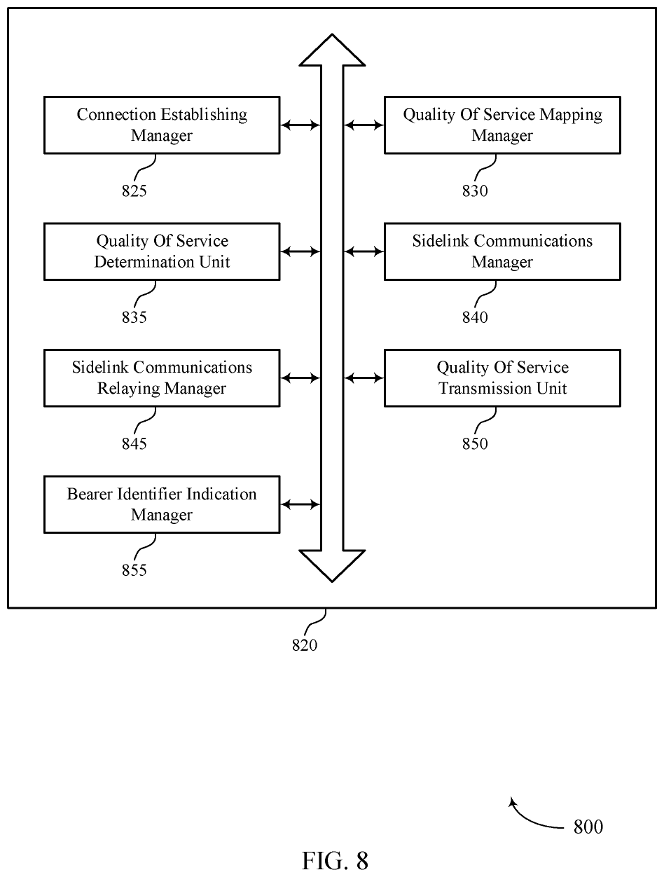

FIG. 8 shows a block diagram 800 of a communications manager 820 that supports techniques for performing QoS management for sidelink communications in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for performing QOS management for sidelink communications as described herein. For example, the communications manager 820 may include a connection establishing manager 825, a QoS mapping manager 830, a QoS determination unit 835, a sidelink communications manager 840, a sidelink communications relaying manager 845, a QoS transmission unit 850, a bearer identifier indication manager 855, or any combination thereof. Each of these components may communicate, directly or indirectly, with one another (e.g., via one or more buses).

The communications manager 820 may support wireless communications at a first wireless device in accordance with examples as disclosed herein. The connection establishing manager 825 may be configured as or otherwise support a means for establishing a first connection with a second wireless device that is in communication with a network entity via a second connection, where the first connection is of a first connection type and the second connection is of a second connection type. The QoS mapping manager 830 may be configured as or otherwise support a means for identifying a mapping between one or more first QoS parameters corresponding to the first connection type and one or more second QoS parameters corresponding to the second connection type. The QoS determination unit 835 may be configured as or otherwise support a means for determining, using the mapping, a first QoS parameter to be applied to the first connection as part of an end-to-end connection with the network entity via the second wireless device. The sidelink communications manager 840 may be configured as or otherwise support a means for communicating with the network entity via the second wireless device using the end-to-end connection.

In some examples, the QoS mapping manager 830 may be configured as or otherwise support a means for receiving an indication of the mapping between the one or more first QoS parameters corresponding to the first connection type and the one or more second QoS parameters corresponding to the second connection type.

In some examples, to support receiving the indication of the mapping, the QoS mapping manager 830 may be configured as or otherwise support a means for receiving the indication of the mapping during Proximity Services Policy provisioning by a Policy Control Function.

In some examples, to support receiving the indication of the mapping, the QoS mapping manager 830 may be configured as or otherwise support a means for receiving the indication of the mapping in a synchronization signal block, or a radio resource control message.

In some examples, the QoS transmission unit 850 may be configured as or otherwise support a means for receiving an indication of the one or more second QoS parameters corresponding to the second connection type, where determining the first Qos parameter to be applied to the first connection is based on the indication.

In some examples, to support receiving the indication, the QoS transmission unit 850 may be configured as or otherwise support a means for receiving, from the second wireless device, a radio resource control reconfiguration message including the indication of the one or more second QoS parameters.

In some examples, the QoS transmission unit 850 may be configured as or otherwise support a means for transmitting, to the second wireless device, an indication of the first QoS parameter to be applied to the first connection as part of the end-to-end connection with the network entity via the second wireless device.

In some examples, to support identifying the mapping, the QOS mapping manager 830 may be configured as or otherwise support a means for identifying that the mapping between the one or more first QoS parameters and the one or more second QoS parameters includes an association between 5QI table entries to PQI table entries.

In some examples, to support identifying the mapping, the QoS mapping manager 830 may be configured as or otherwise support a means for identifying that the mapping between the one or more first QoS parameters and the one or more second QoS parameters includes an association between second connection QoS flow priority values to first connection QoS flow priority values.

In some examples, to support identifying the mapping, the QoS mapping manager 830 may be configured as or otherwise support a means for identifying that the mapping is associated with the first wireless device in a UE-specific manner, or the mapping is associated with a set of multiple first wireless devices.

In some examples, the first wireless device is operating in accordance with a resource allocation mode 1 when the first connection is a sidelink connection type, and the bearer identifier indication manager 855 may be configured as or otherwise support a means for transmitting an indication of an end-to-end bearer identifier associated with the first wireless device, the one or more first QoS parameters, an identifier of the second wireless device, a reference signal received power associated with the first connection type, or a combination thereof.

In some examples, the one or more first QoS parameters, or the one or more second QoS parameters, or both include a priority of the second connection type, a prioritized bitrate, a value associated with the second connection type, a resource type, a packet delay budget, a packet error rate, a data burst volume, an averaging window, or a combination thereof.

In some examples, the one or more second QoS parameters are based on a 5QI of an end-to-end radio bearer. The first connection may be a sidelink connection, a Wi-Fi connection, a Bluetooth connection, a device-to-device connection, or a peer-to-peer connection

Additionally or alternatively, the communications manager 820 may support wireless communications at a first wireless device in accordance with examples as disclosed herein. In some examples, the connection establishing manager 825 may be configured as or otherwise support a means for establishing a first connection with a second wireless device, where the first wireless device is in communication with a network entity via a second connection, the first connection is of a first connection type and the second connection is of a second connection type. In some examples, the QoS mapping manager 830 may be configured as or otherwise support a means for identifying a mapping between one or more first QoS parameters corresponding to the first connection type and one or more second Qos parameters corresponding to the second connection type. In some examples, the QoS determination unit 835 may be configured as or otherwise support a means for determining, using the mapping, a first QoS parameter to be applied to the first connection as part of an end-to-end connection between the network entity and second wireless device via the first wireless device. The sidelink communications relaying manager 845 may be configured as or otherwise support a means for relaying communications between the network entity and the second wireless device using the end-to-end connection.

In some examples, the QoS mapping manager 830 may be configured as or otherwise support a means for receiving an indication of the mapping between the one or more first QoS parameters corresponding to the first connection type and the one or more second QoS parameters corresponding to the second connection type.

In some examples, to support receiving the indication of the mapping, the QoS mapping manager 830 may be configured as or otherwise support a means for receiving the indication of the mapping during Proximity Services Policy provisioning by a Policy Control Function.

In some examples, to support receiving the indication of the mapping, the QoS mapping manager 830 may be configured as or otherwise support a means for receiving the indication of the mapping in a synchronization signal block, or a radio resource control message.

In some examples, the QoS transmission unit 850 may be configured as or otherwise support a means for transmitting, to the second wireless device, a first indication of the one or more first QoS parameters corresponding to the first connection type, a second indication of the one or more second QoS parameters corresponding to the second connection type, or both.

In some examples, to support transmitting the first indication or the second indication, the QoS transmission unit 850 may be configured as or otherwise support a means for transmitting, from the first wireless device, a radio resource control reconfiguration message including the first indication, the second indication, or both.

In some examples, the QoS determination unit 835 may be configured as or otherwise support a means for receiving, from the network entity of the second wireless device, an indication of the one or more second QoS parameters corresponding to the second connection type, where determining the first QoS parameter to be applied to the first connection is based on the indication.

In some examples, to support receiving the indication, the QoS determination unit 835 may be configured as or otherwise support a means for receiving a radio resource control reconfiguration message including the indication of the one or more second QoS parameters.

In some examples, to support identifying the mapping, the QoS mapping manager 830 may be configured as or otherwise support a means for identifying that the mapping between the one or more first QoS parameters and the one or more second QoS parameters includes an association between 5QI table entries to PQI table entries.

In some examples, to support identifying the mapping, the QoS mapping manager 830 may be configured as or otherwise support a means for identifying that the mapping between the one or more first QoS parameters and the one or more second QoS parameters includes an association between second connection QoS flow priority values to first connection QoS flow priority values.

In some examples, to support identifying the mapping, the QoS mapping manager 830 may be configured as or otherwise support a means for identifying that the mapping is associated with the second wireless device in a UE-specific manner, or the mapping is associated with a set of multiple second wireless devices.

In some examples, the first wireless device is operating in accordance with a random access mode 1 when the first connection is a sidelink connection type, and the bearer identifier indication manager 855 may be configured as or otherwise support a means for transmitting an indication of a bearer identifier of the second wireless device, a reference signal received power associated with the first connection type, or a combination thereof.

In some examples, the bearer identifier indication manager 855 may be configured as or otherwise support a means for determining a first connection type bearer based on a second connection type bearer. In some examples, the bearer identifier indication manager 855 may be configured as or otherwise support a means for transmitting an indication of the second connection type bearer to the second wireless device via a radio resource control reconfiguration message.

In some examples, the bearer identifier indication manager 855 may be configured as or otherwise support a means for utilizing a first connection type bearer configuration for the second wireless device via a radio resource control reconfiguration message.

In some examples, the one or more first QoS parameters, or the one or more second QoS parameters, or both include a priority of the second connection type, prioritized bitrates, a value associated with the second connection type, a resource type, a packet delay budget, a packet error rate, a data burst volume, an averaging window, or a combination thereof.

In some examples, the one or more second QoS parameters are based on a 5QI of an end-to-end radio bearer.

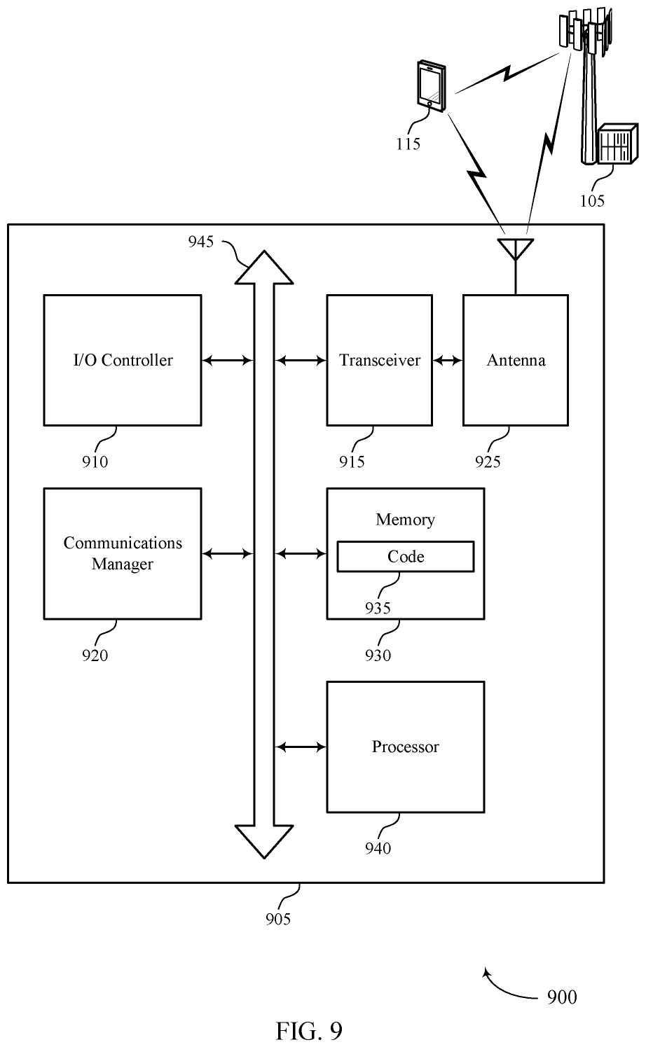

FIG. 9 shows a diagram of a system 900 including a device 905 that supports techniques for performing QoS management for sidelink communications in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for performing QoS management for sidelink communications). For example, the device 905 or a component of the device 905 may include a processor 940 and memory 930 coupled to the processor 940, the processor 940 and memory 930 configured to perform various functions described herein.

The communications manager 920 may support wireless communications at a first wireless device in accordance with examples as disclosed herein. For example, the communications manager 920 may be configured as or otherwise support a means for establishing a first connection with a second wireless device that is in communication with a network entity via a second connection, where the first connection is of a first connection type and the second connection is of a second connection type. The communications manager 920 may be configured as or otherwise support a means for identifying a mapping between one or more first QoS parameters corresponding to the first connection type and one or more second QoS parameters corresponding to the second connection type. The communications manager 920 may be configured as or otherwise support a means for determining, using the mapping, a first QoS parameter to be applied to the first connection as part of an end-to-end connection with the network entity via the second wireless device. The communications manager 920 may be configured as or otherwise support a means for communicating with the network entity via the second wireless device using the end-to-end connection.

Additionally or alternatively, the communications manager 920 may support wireless communications at a first wireless device in accordance with examples as disclosed herein. For example, the communications manager 920 may be configured as or otherwise support a means for establishing a first connection with a second wireless device, where the first wireless device is in communication with a network entity via a second connection, the first connection is of a first connection type and the second connection is of a second connection type. The communications manager 920 may be configured as or otherwise support a means for identifying a mapping between one or more first QoS parameters corresponding to the first connection type and one or more second QoS parameters corresponding to the second connection type. The communications manager 920 may be configured as or otherwise support a means for determining, using the mapping, a first QoS parameter to be applied to the first connection as part of an end-to-end connection between the network entity and second wireless device via the first wireless device. The communications manager 920 may be configured as or otherwise support a means for relaying communications between the network entity and the second wireless device using the end-to-end connection.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for performing QoS management for sidelink communications as described herein, or the processor 940 and the memory 930 may be otherwise configured to perform or support such operations.

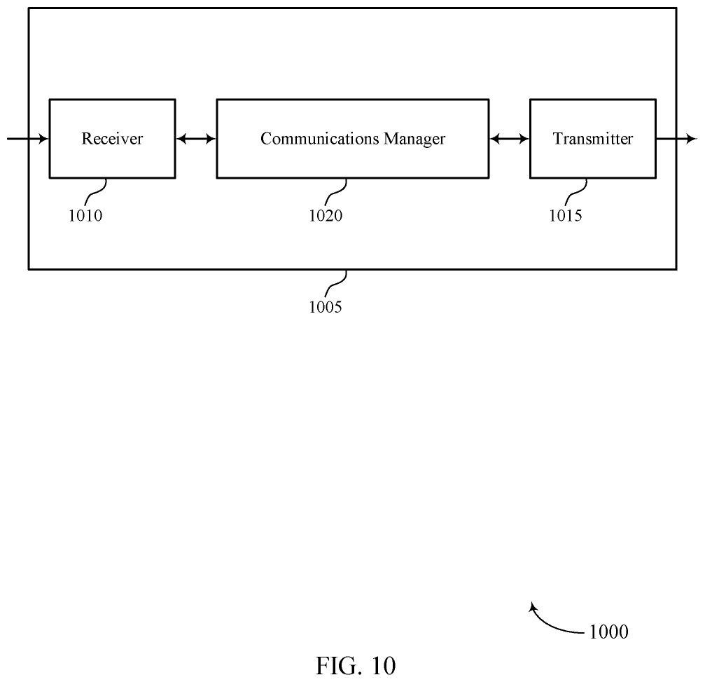

FIG. 10 shows a block diagram 1000 of a device 1005 that supports techniques for performing QoS management for sidelink communications in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for performing QoS management for sidelink communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for performing QoS management for sidelink communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for performing QoS management for sidelink communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a network entity in accordance with examples as disclosed herein. For example, the communications manager 1020 may be configured as or otherwise support a means for establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The communications manager 1020 may be configured as or otherwise support a means for identifying a mapping between one or more first QoS parameters corresponding to the first connection type and one or more second QoS parameters corresponding to the second connection type. The communications manager 1020 may be configured as or otherwise support a means for communicating with the first wireless device via the second wireless device using the end-to-end connection.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, and more efficient utilization of communication resources.

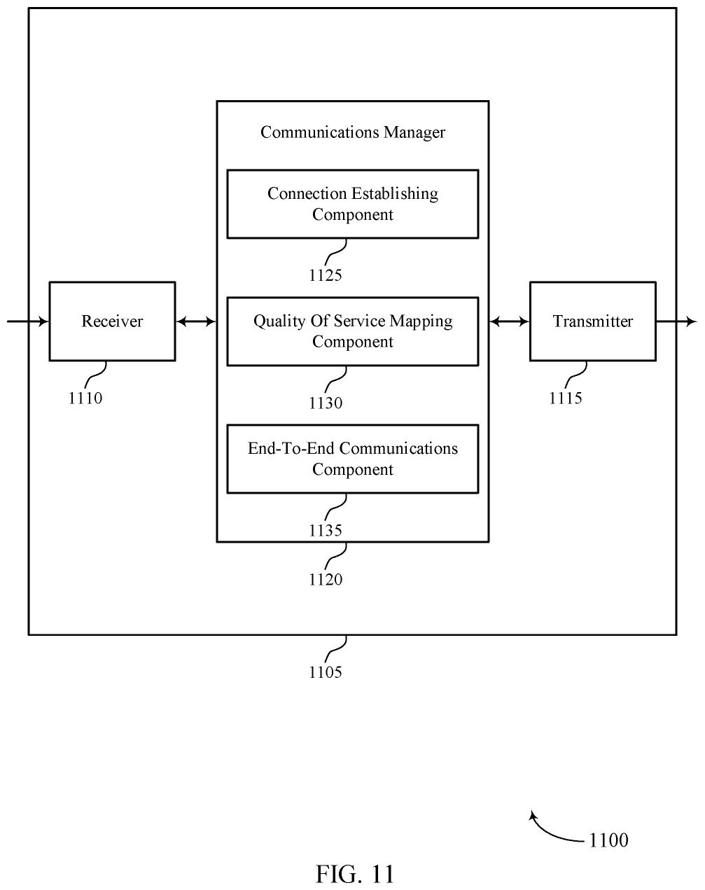

FIG. 11 shows a block diagram 1100 of a device 1105 that supports techniques for performing QoS management for sidelink communications in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for performing QoS management for sidelink communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for performing QoS management for sidelink communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for performing QoS management for sidelink communications as described herein. For example, the communications manager 1120 may include a connection establishing component 1125, a QoS mapping component 1130, an end-to-end communications component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a network entity in accordance with examples as disclosed herein. The connection establishing component 1125 may be configured as or otherwise support a means for establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The QoS mapping component 1130 may be configured as or otherwise support a means for identifying a mapping between one or more first QoS parameters corresponding to the first connection type and one or more second Qos parameters corresponding to the second connection type. The end-to-end communications component 1135 may be configured as or otherwise support a means for communicating with the first wireless device via the second wireless device using the end-to-end connection.

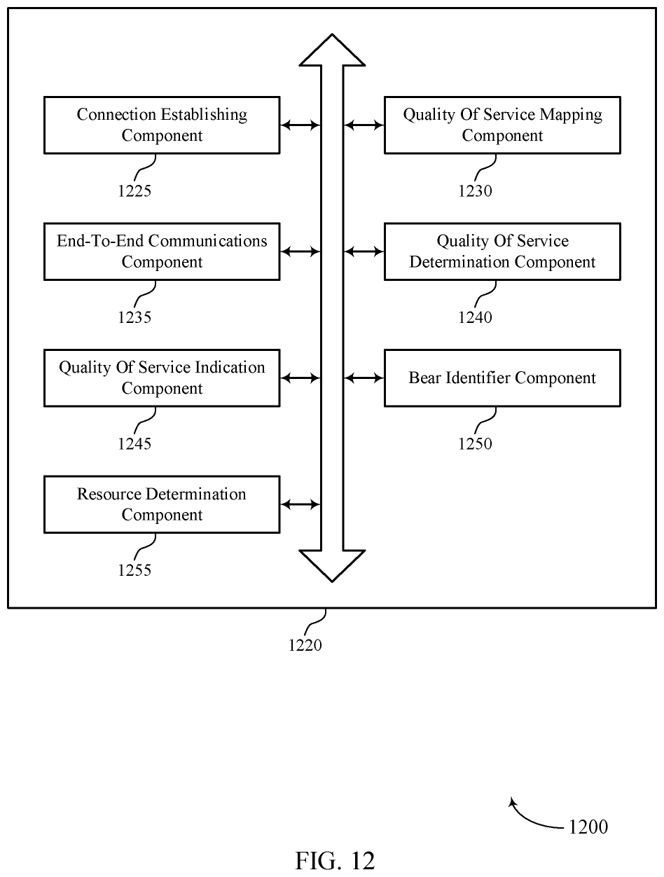

FIG. 12 shows a block diagram 1200 of a communications manager 1220 that supports techniques for performing QoS management for sidelink communications in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for performing QoS management for sidelink communications as described herein. For example, the communications manager 1220 may include a connection establishing component 1225, a QoS mapping component 1230, an end-to-end communications component 1235, a QoS determination component 1240, a QoS indication component 1245, a bear identifier component 1250, a resource determination component 1255, or any combination thereof. Each of these components may communicate, directly or indirectly, with one another (e.g., via one or more buses).

The communications manager 1220 may support wireless communications at a network entity in accordance with examples as disclosed herein. The connection establishing component 1225 may be configured as or otherwise support a means for establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The QoS mapping component 1230 may be configured as or otherwise support a means for identifying a mapping between one or more first QoS parameters corresponding to the first connection type and one or more second QoS parameters corresponding to the second connection type. The end-to-end communications component 1235 may be configured as or otherwise support a means for communicating with the first wireless device via the second wireless device using the end-to-end connection.

In some examples, the QoS mapping component 1230 may be configured as or otherwise support a means for receiving an indication of the mapping between the one or more first QoS parameters and the one or more second QoS parameters.

In some examples, to support receiving the indication of the mapping, the QoS mapping component 1230 may be configured as or otherwise support a means for receiving the indication of the mapping from an access and mobility management Function.

In some examples, to support receiving the indication of the mapping, the QoS mapping component 1230 may be configured as or otherwise support a means for receiving the indication of the mapping from a session management function via the access and mobility management Function.

In some examples, to support receiving the indication of the mapping, the QoS mapping component 1230 may be configured as or otherwise support a means for receiving the indication of the mapping during a UE Policy Association Establishment procedure, a UE Policy Association Modification procedure, or both.

In some examples, to support receiving the indication of the mapping, the QoS mapping component 1230 may be configured as or otherwise support a means for receiving the indication of the mapping during a UE Protocol Data Unit session establishment procedure, a UE Protocol Data Unit session modification procedure, or both.

In some examples, the QoS determination component 1240 may be configured as or otherwise support a means for determining a QoS split between the first connection and the second connection.

In some examples, to support determining the QoS split, the QoS determination component 1240 may be configured as or otherwise support a means for determining the one or more second QoS parameters corresponding to the second connection type based on a 5QI configuration associated with an end-to-end bearer of the first wireless device.

In some examples, the QoS indication component 1245 may be configured as or otherwise support a means for transmitting, to the second wireless device, an indication of the one or more second QoS parameters corresponding to the second connection type.

In some examples, to support transmitting the indication, the QoS indication component 1245 may be configured as or otherwise support a means for transmitting a radio resource control reconfiguration message including the indication of the one or more second QoS parameters.

In some examples, to support identifying the mapping, the QoS mapping component 1230 may be configured as or otherwise support a means for identifying that the mapping between the one or more first QoS parameters and the one or more second QoS parameters includes an association between 5QI table entries to PQI table entries.

In some examples, to support identifying the mapping, the QoS mapping component 1230 may be configured as or otherwise support a means for identifying that the mapping between the one or more first QoS parameters and the one or more second QoS parameters includes an association between second connection QoS flow priority values to first connection QoS flow priority values.

In some examples, to support identifying the mapping, the QoS mapping component 1230 may be configured as or otherwise support a means for identifying that the mapping is associated with the first wireless device in a UE-specific manner, or the mapping is associated with a set of multiple first wireless devices.

In some examples, the first wireless device, and the bear identifier component 1250 may be configured as or otherwise support a means for receiving an indication of an end-to-end bearer identifier associated with the first wireless device, the one or more first QOS parameters, an identifier of the second wireless device, a reference signal received power associated with the first connection type, or a combination thereof.

In some examples, the QoS determination component 1240 may be configured as or otherwise support a means for determining the one or more first QoS parameters corresponding to the first connection type based on the indication and the mapping.

In some examples, the resource determination component 1255 may be configured as or otherwise support a means for determining mode 1 resources for the first connection based on the indication.

In some examples, the one or more first QoS parameters, or the one or more second QoS parameters, or both include a priority of the second connection type, prioritized bitrates, a value associated with the second connection type, a resource type, a packet delay budget, a packet error rate, a data burst volume, an averaging window, or a combination thereof.

In some examples, the one or more second QoS parameters are based on a 5QI of an end-to-end radio bearer.

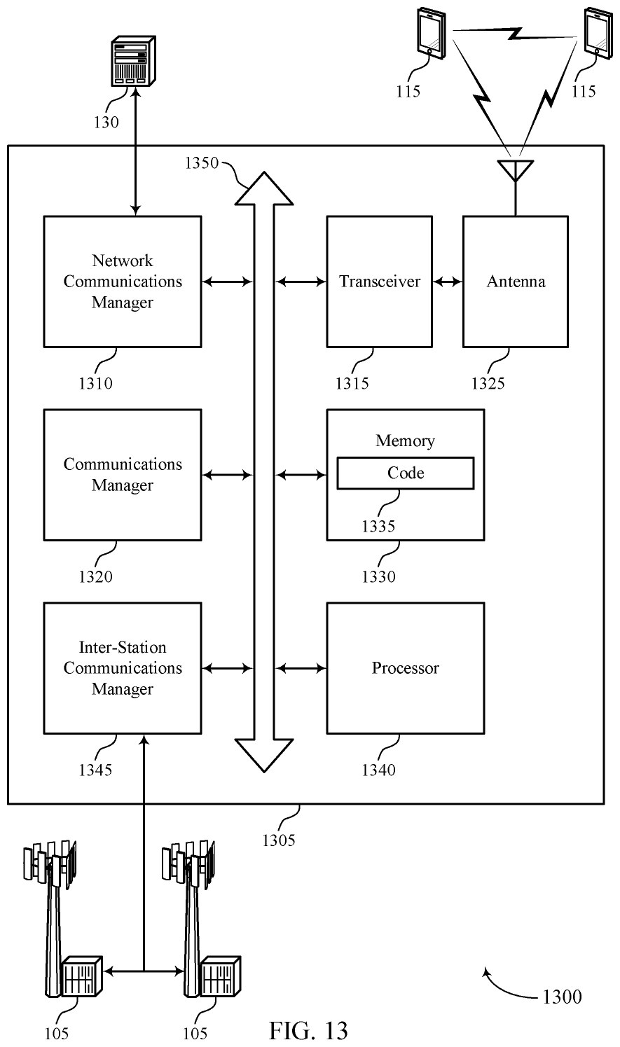

FIG. 13 shows a diagram of a system 1300 including a device 1305 that supports techniques for performing QoS management for sidelink communications in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for performing QoS management for sidelink communications). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a network entity in accordance with examples as disclosed herein. For example, the communications manager 1320 may be configured as or otherwise support a means for establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The communications manager 1320 may be configured as or otherwise support a means for identifying a mapping between one or more first QoS parameters corresponding to the first connection type and one or more second QoS parameters corresponding to the second connection type. The communications manager 1320 may be configured as or otherwise support a means for communicating with the first wireless device via the second wireless device using the end-to-end connection.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for performing QoS management for sidelink communications as described herein, or the processor 1340 and the memory 1330 may be otherwise configured to perform or support such operations.

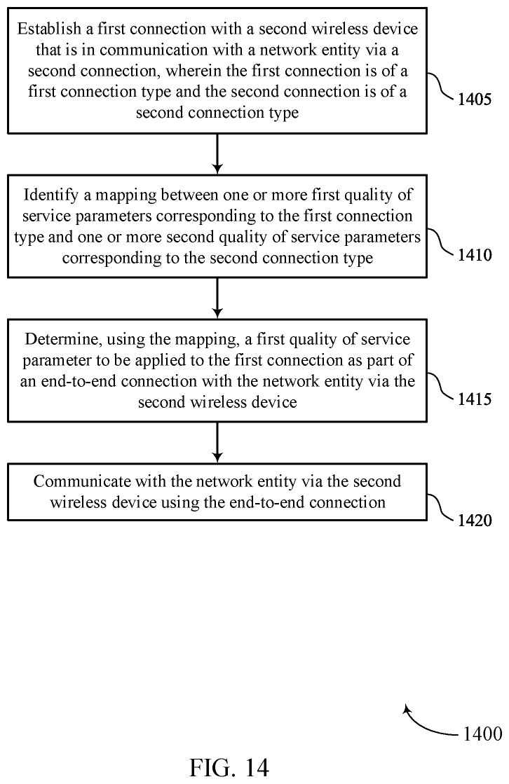

FIG. 14 shows a flowchart illustrating a method 1400 that supports techniques for performing QoS management for sidelink communications in accordance with aspects of the present disclosure. The operations of the method 1400 may be implemented by a wireless device (e.g., a UE) or its components as described herein. For example, the operations of the method 1400 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1405, the method may include establishing a first connection with a second wireless device that is in communication with a network entity via a second connection, where the first connection is of a first connection type and the second connection is of a second connection type. The operations of 1405 may be performed in accordance with examples as disclosed herein. In some examples, aspects of the operations of 1405 may be performed by a connection establishing manager 825 as described with reference to FIG. 8.

At 1410, the method may include identifying a mapping between one or more first QoS parameters corresponding to the first connection type and one or more second Qos parameters corresponding to the second connection type. The operations of 1410 may be performed in accordance with examples as disclosed herein. In some examples, aspects of the operations of 1410 may be performed by a QoS mapping manager 830 as described with reference to FIG. 8.

At 1415, the method may include determining, using the mapping, a first QoS parameter to be applied to the first connection as part of an end-to-end connection with the network entity via the second wireless device. The operations of 1415 may be performed in accordance with examples as disclosed herein. In some examples, aspects of the operations of 1415 may be performed by a QoS determination unit 835 as described with reference to FIG. 8.

At 1420, the method may include communicating with the network entity via the second wireless device using the end-to-end connection. The operations of 1420 may be performed in accordance with examples as disclosed herein. In some examples, aspects of the operations of 1420 may be performed by a sidelink communications manager 840 as described with reference to FIG. 8.

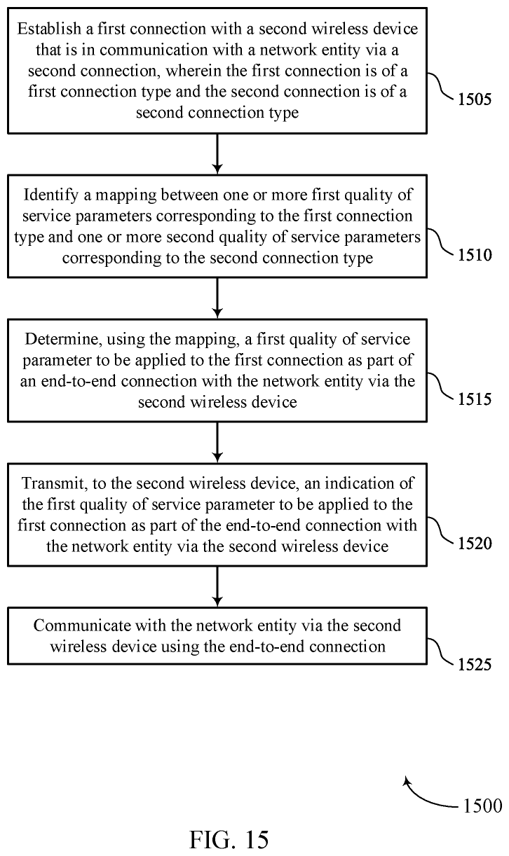

FIG. 15 shows a flowchart illustrating a method 1500 that supports techniques for performing QoS management for sidelink communications in accordance with aspects of the present disclosure. The operations of the method 1500 may be implemented by a wireless device (e.g., a UE) or its components as described herein. For example, the operations of the method 1500 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1505, the method may include establishing a first connection with a second wireless device that is in communication with a network entity via a second connection, where the first connection is of a first connection type and the second connection is of a second connection type. The operations of 1505 may be performed in accordance with examples as disclosed herein. In some examples, aspects of the operations of 1505 may be performed by a connection establishing manager 825 as described with reference to FIG. 8.

At 1510, the method may include identifying a mapping between one or more first QoS parameters corresponding to the first connection type and one or more second QoS parameters corresponding to the second connection type. The operations of 1510 may be performed in accordance with examples as disclosed herein. In some examples, aspects of the operations of 1510 may be performed by a QoS mapping manager 830 as described with reference to FIG. 8.

At 1515, the method may include determining, using the mapping, a first QoS parameter to be applied to the first connection as part of an end-to-end connection with the network entity via the second wireless device. The operations of 1515 may be performed in accordance with examples as disclosed herein. In some examples, aspects of the operations of 1515 may be performed by a QoS determination unit 835 as described with reference to FIG. 8.

At 1520, the method may include transmitting, to the second wireless device, an indication of the first QoS parameter to be applied to the first connection as part of the end-to-end connection with the network entity via the second wireless device. The operations of 1520 may be performed in accordance with examples as disclosed herein. In some examples, aspects of the operations of 1520 may be performed by a QoS transmission unit 850 as described with reference to FIG. 8.

At 1525, the method may include communicating with the network entity via the second wireless device using the end-to-end connection. The operations of 1525 may be performed in accordance with examples as disclosed herein. In some examples, aspects of the operations of 1525 may be performed by a sidelink communications manager 840 as described with reference to FIG. 8.

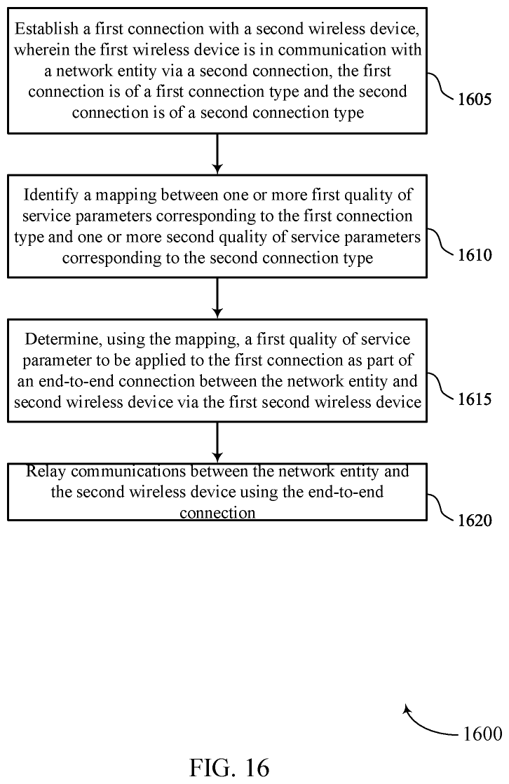

FIG. 16 shows a flowchart illustrating a method 1600 that supports techniques for performing QoS management for sidelink communications in accordance with aspects of the present disclosure. The operations of the method 1600 may be implemented by a wireless device (e.g., a UE) or its components as described herein. For example, the operations of the method 1600 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1605, the method may include establishing a first connection with a second wireless device, where the first wireless device is in communication with a network entity via a second connection, the first connection is of a first connection type and the second connection is of a second connection type. The operations of 1605 may be performed in accordance with examples as disclosed herein. In some examples, aspects of the operations of 1605 may be performed by a connection establishing manager 825 as described with reference to FIG. 8.

At 1610, the method may include identifying a mapping between one or more first QoS parameters corresponding to the first connection type and one or more second QoS parameters corresponding to the second connection type. The operations of 1610 may be performed in accordance with examples as disclosed herein. In some examples, aspects of the operations of 1610 may be performed by a QoS mapping manager 830 as described with reference to FIG. 8.

At 1615, the method may include determining, using the mapping, a first QoS parameter to be applied to the first connection as part of an end-to-end connection between the network entity and second wireless device via the first wireless device. The operations of 1615 may be performed in accordance with examples as disclosed herein. In some examples, aspects of the operations of 1615 may be performed by a QoS determination unit 835 as described with reference to FIG. 8.

At 1620, the method may include relaying communications between the network entity and the second wireless device using the end-to-end connection. The operations of 1620 may be performed in accordance with examples as disclosed herein. In some examples, aspects of the operations of 1620 may be performed by a sidelink communications relaying manager 845 as described with reference to FIG. 8.

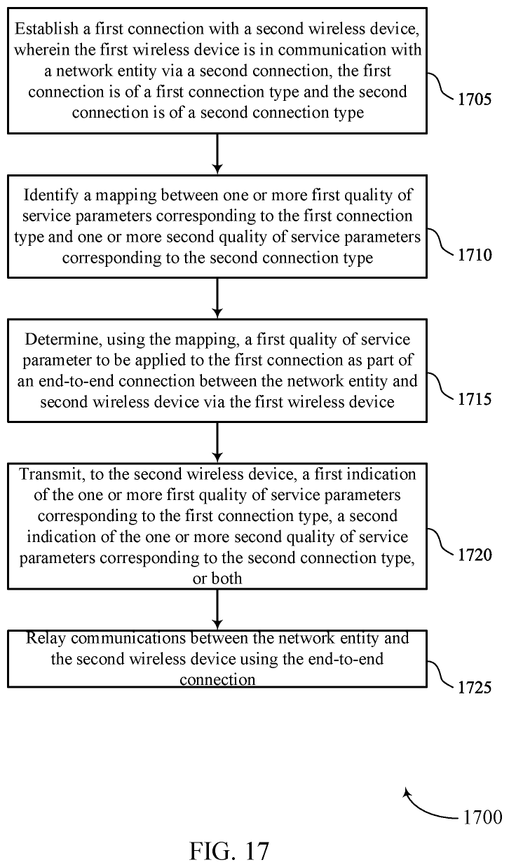

FIG. 17 shows a flowchart illustrating a method 1700 that supports techniques for performing QoS management for sidelink communications in accordance with aspects of the present disclosure. The operations of the method 1700 may be implemented by a wireless device (e.g., a UE) or its components as described herein. For example, the operations of the method 1700 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1705, the method may include establishing a first connection with a second wireless device, where the first wireless device is in communication with a network entity via a second connection, the first connection is of a first connection type and the second connection is of a second connection type. The operations of 1705 may be performed in accordance with examples as disclosed herein. In some examples, aspects of the operations of 1705 may be performed by a connection establishing manager 825 as described with reference to FIG. 8.

At 1710, the method may include identifying a mapping between one or more first QoS parameters corresponding to the first connection type and one or more second QoS parameters corresponding to the second connection type. The operations of 1710 may be performed in accordance with examples as disclosed herein. In some examples, aspects of the operations of 1710 may be performed by a QoS mapping manager 830 as described with reference to FIG. 8.

At 1715, the method may include determining, using the mapping, a first QoS parameter to be applied to the first connection as part of an end-to-end connection between the network entity and second wireless device via the first wireless device. The operations of 1715 may be performed in accordance with examples as disclosed herein. In some examples, aspects of the operations of 1715 may be performed by a QoS determination unit 835 as described with reference to FIG. 8.

At 1720, the method may include transmitting, to the second wireless device, a first indication of the one or more first QoS parameters corresponding to the first connection type, a second indication of the one or more second QoS parameters corresponding to the second connection type, or both. The operations of 1720 may be performed in accordance with examples as disclosed herein. In some examples, aspects of the operations of 1720 may be performed by a QoS transmission unit 850 as described with reference to FIG. 8.

At 1725, the method may include relaying communications between the network entity and the second wireless device using the end-to-end connection. The operations of 1725 may be performed in accordance with examples as disclosed herein. In some examples, aspects of the operations of 1725 may be performed by a sidelink communications relaying manager 845 as described with reference to FIG. 8.

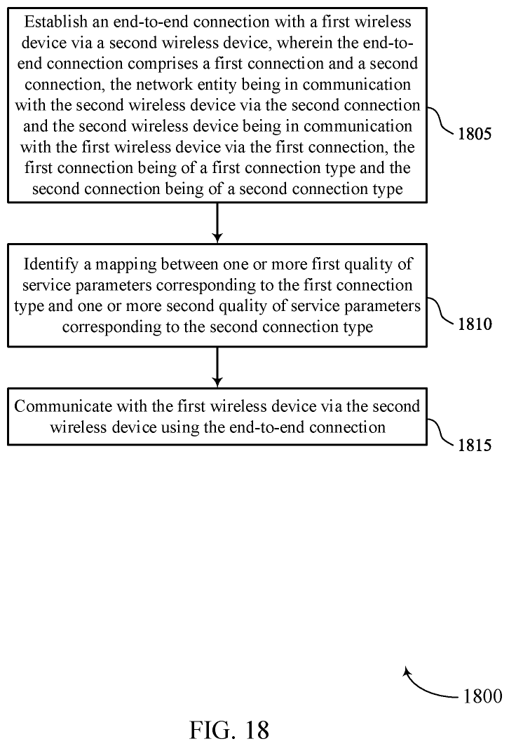

FIG. 18 shows a flowchart illustrating a method 1800 that supports techniques for performing QoS management for sidelink communications in accordance with aspects of the present disclosure. The operations of the method 1800 may be implemented by a network entity (e.g., base station, network device) or its components as described herein. For example, the operations of the method 1800 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1805, the method may include establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The operations of 1805 may be performed in accordance with examples as disclosed herein. In some examples, aspects of the operations of 1805 may be performed by a connection establishing component 1225 as described with reference to FIG. 12.

At 1810, the method may include identifying a mapping between one or more first QoS parameters corresponding to the first connection type and one or more second Qos parameters corresponding to the second connection type. The operations of 1810 may be performed in accordance with examples as disclosed herein. In some examples, aspects of the operations of 1810 may be performed by a QoS mapping component 1230 as described with reference to FIG. 12.

At 1815, the method may include communicating with the first wireless device via the second wireless device using the end-to-end connection. The operations of 1815 may be performed in accordance with examples as disclosed herein. In some examples, aspects of the operations of 1815 may be performed by an end-to-end communications component 1235 as described with reference to FIG. 12.

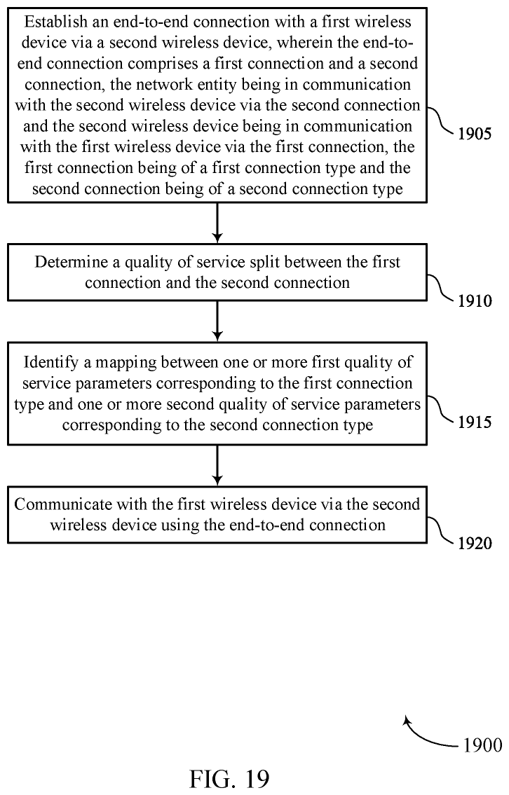

FIG. 19 shows a flowchart illustrating a method 1900 that supports techniques for performing QoS management for sidelink communications in accordance with aspects of the present disclosure. The operations of the method 1900 may be implemented by a network entity (e.g., base station, network device) or its components as described herein. For example, the operations of the method 1900 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1905, the method may include establishing an end-to-end connection with a first wireless device via a second wireless device, where the end-to-end connection includes a first connection and a second connection, the network entity being in communication with the second wireless device via the second connection and the second wireless device being in communication with the first wireless device via the first connection, the first connection being of a first connection type and the second connection being of a second connection type. The operations of 1905 may be performed in accordance with examples as disclosed herein. In some examples, aspects of the operations of 1905 may be performed by a connection establishing component 1225 as described with reference to FIG. 12.

At 1910, the method may include determining a QoS split between the first connection and the second connection. The operations of 1910 may be performed in accordance with examples as disclosed herein. In some examples, aspects of the operations of 1910 may be performed by a QoS determination component 1240 as described with reference to FIG. 12.

At 1915, the method may include identifying a mapping between one or more first QoS parameters corresponding to the first connection type and one or more second QoS parameters corresponding to the second connection type. The operations of 1915 may be performed in accordance with examples as disclosed herein. In some examples, aspects of the operations of 1915 may be performed by a QoS mapping component 1230 as described with reference to FIG. 12.

At 1920, the method may include communicating with the first wireless device via the second wireless device using the end-to-end connection. The operations of 1920 may be performed in accordance with examples as disclosed herein. In some examples, aspects of the operations of 1920 may be performed by an end-to-end communications component 1235 as described with reference to FIG. 12.

The following provides an overview of aspects of the present disclosure:

Aspect 1: A method for wireless communications at a first wireless device, comprising: establishing a first connection with a second wireless device that is in communication with a network entity via a second connection, wherein the first connection is of a first connection type and the second connection is of a second connection type; identifying a mapping between one or more first quality of service parameters corresponding to the first connection type and one or more second quality of service parameters corresponding to the second connection type; determining, using the mapping, a first quality of service parameter to be applied to the first connection as part of an end-to-end connection with the network entity via the second wireless device; and communicating with the network entity via the second wireless device using the end-to-end connection.

Aspect 2: The method of aspect 1, further comprising: receiving an indication of the mapping between the one or more first quality of service parameters corresponding to the first connection type and the one or more second quality of service parameters corresponding to the second connection type.

Aspect 3: The method of aspect 2, wherein receiving the indication of the mapping further comprises: receiving the indication of the mapping during Proximity Services Policy provisioning by a Policy Control Function.

Aspect 4: The method of any of aspects 2 through 3, wherein receiving the indication of the mapping further comprises: receiving the indication of the mapping in a synchronization signal block, or a radio resource control message.

Aspect 5: The method of any of aspects 1 through 4, further comprising: receiving an indication of the one or more second quality of service parameters corresponding to the second connection type, wherein determining the first quality of service parameter to be applied to the first connection is based at least in part on the indication.

Aspect 6: The method of aspect 5, wherein receiving the indication further comprises: receiving, from the second wireless device, a radio resource control reconfiguration message comprising the indication of the one or more second quality of service parameters.

Aspect 7: The method of any of aspects 1 through 6, further comprising: transmitting, to the second wireless device, an indication of the first quality of service parameter to be applied to the first connection as part of the end-to-end connection with the network entity via the second wireless device.

Aspect 8: The method of any of aspects 1 through 7, wherein identifying the mapping further comprises: identifying that the mapping between the one or more first quality of service parameters and the one or more second quality of service parameters comprises an association between 5QI table entries to PQI table entries.

Aspect 9: The method of any of aspects 1 through 8, wherein identifying the mapping further comprises: identifying that the mapping between the one or more first quality of service parameters and the one or more second quality of service parameters comprises an association between second connection quality of service flow priority values to first connection quality of service flow priority values.

Aspect 10: The method of any of aspects 1 through 9, wherein identifying the mapping further comprises: identifying that the mapping is associated with the first wireless device in a UE-specific manner, or the mapping is associated with a plurality of first wireless devices.

Aspect 11: The method of any of aspects 1 through 10, wherein the first wireless device is operating in accordance with a resource allocation mode 1 when the first connection is a sidelink connection type, the method further comprises: transmitting an indication of an end-to-end bearer identifier associated with the first wireless device, the one or more first quality of service parameters, an identifier of the second wireless device, a reference signal received power associated with the first connection type, or a combination thereof.

Aspect 12: The method of any of aspects 1 through 11, wherein the one or more first quality of service parameters, or the one or more second quality of service parameters, or both comprise a priority of the second connection type, a prioritized bitrate, a value associated with the second connection type, a resource type, a packet delay budget, a packet error rate, a data burst volume, an averaging window, or a combination thereof.

Aspect 13: The method of any of aspects 1 through 12, wherein the one or more second quality of service parameters are based at least in part on a 5QI of an end-to-end radio bearer.

Aspect 14: The method of any of aspects 1 through 13, wherein the first connection is a sidelink connection, a Wi-Fi connection, a Bluetooth connection, a device-to-device connection, or a peer-to-peer connection.

Aspect 15: A method for wireless communications at a first wireless device, comprising: establishing a first connection with a second wireless device, wherein the first wireless device is in communication with a network entity via a second connection, the first connection is of a first connection type and the second connection is of a second connection type; identifying a mapping between one or more first quality of service parameters corresponding to the first connection type and one or more second quality of service parameters corresponding to the second connection type; determining, using the mapping, a first quality of service parameter to be applied to the first connection as part of an end-to-end connection between the network entity and second wireless device via the first wireless device; and relaying communications between the network entity and the second wireless device using the end-to-end connection.

Aspect 16: The method of aspect 15, further comprising: receiving an indication of the mapping between the one or more first quality of service parameters corresponding to the first connection type and the one or more second quality of service parameters corresponding to the second connection type.

Aspect 17: The method of aspect 16, wherein receiving the indication of the mapping further comprises: receiving the indication of the mapping during Proximity Services Policy provisioning by a Policy Control Function.

Aspect 18: The method of any of aspects 16 through 17, wherein receiving the indication of the mapping further comprises: receiving the indication of the mapping in a synchronization signal block, or a radio resource control message.

Aspect 19: The method of any of aspects 15 through 18, further comprising: transmitting, to the second wireless device, a first indication of the one or more first quality of service parameters corresponding to the first connection type.

Aspect 20: The method of aspect 19, wherein transmitting the first indication or the second indication further comprises: transmitting, from the first wireless device, a radio resource control reconfiguration message comprising the first indication, the second indication, or both.

Aspect 21: The method of any of aspects 15 through 20, further comprising: receiving, from the network entity or the second wireless device, an indication of the one or more second quality of service parameters corresponding to the second connection type, wherein determining the first quality of service parameter to be applied to the first connection is based at least in part on the indication.

Aspect 22: The method of aspect 21, wherein receiving the indication further comprises: receiving a radio resource control reconfiguration message comprising the indication of the one or more second quality of service parameters.

Aspect 23: The method of any of aspects 15 through 22, wherein identifying the mapping further comprises: identifying that the mapping between the one or more first quality of service parameters and the one or more second quality of service parameters comprises an association between 5QI table entries to PQI table entries.

Aspect 24: The method of any of aspects 15 through 23, wherein identifying the mapping further comprises: identifying that the mapping between the one or more first quality of service parameters and the one or more second quality of service parameters comprises an association between second connection quality of service flow priority values to first connection quality of service flow priority values.

Aspect 25: The method of any of aspects 15 through 24, wherein identifying the mapping further comprises: identifying that the mapping is associated with the second wireless device in a UE-specific manner, or the mapping is associated with a plurality of second wireless devices.

Aspect 26: The method of any of aspects 15 through 25, wherein the first wireless device is operating in accordance with a random access mode 1 when the first connection is a sidelink connection type, the method further comprises: transmitting an indication of a bearer identifier of the second wireless device, a reference signal received power associated with the first connection type, or a combination thereof.

Aspect 27: The method of any of aspects 15 through 26, further comprising: determining a first connection type bearer based at least in part on a second connection type bearer; and transmitting an indication of the second connection type bearer to the second wireless device via a radio resource control reconfiguration message.

Aspect 28: The method of any of aspects 15 through 27, further comprising: utilizing a first connection type bearer configuration for the second wireless device via a radio resource control reconfiguration message.

Aspect 29: The method of any of aspects 15 through 28, wherein the one or more first quality of service parameters, or the one or more second quality of service parameters, or both comprise a priority of the second connection type, prioritized bitrates, a value associated with the second connection type, a resource type, a packet delay budget, a packet error rate, a data burst volume, an averaging window, or a combination thereof.

Aspect 30: The method of any of aspects 15 through 29, wherein the one or more second quality of service parameters are based at least in part on a 5QI of an end-to-end radio bearer.

Aspect 31: A method for wireless communications at a network entity, comprising: establishing an end-to-end connection with a first wireless device via a second wireless device, wherein the end-to-end connection comprises a first connection and a second connection, the network entity being in communication with the second wireless device via the second connection and the second wireless device being in communication with the first wireless device via the first connection, the first connection being of a first connection type and the second connection being of a second connection type; identifying a mapping between one or more first quality of service parameters corresponding to the first connection type and one or more second quality of service parameters corresponding to the second connection type; and communicating with the first wireless device via the second wireless device using the end-to-end connection.

Aspect 32: The method of aspect 31, further comprising: receiving an indication of the mapping between the one or more first quality of service parameters and the one or more second quality of service parameters.

Aspect 33: The method of aspect 32, wherein receiving the indication of the mapping further comprises: receiving the indication of the mapping from an access and mobility management Function.

Aspect 34: The method of aspect 33, wherein receiving the indication of the mapping further comprises: receiving the indication of the mapping from a session management function via the access and mobility management Function.

Aspect 35: The method of any of aspects 32 through 34, wherein receiving the indication of the mapping further comprises: receiving the indication of the mapping during a UE Policy Association Establishment procedure, a UE Policy Association Modification procedure, or both.

Aspect 36: The method of any of aspects 32 through 35, wherein receiving the indication of the mapping further comprises: receiving the indication of the mapping during a UE Protocol Data Unit session establishment procedure, a UE Protocol Data Unit session modification procedure, or both.

Aspect 37: The method of any of aspects 31 through 36, further comprising: determining a quality of service split between the first connection and the second connection.

Aspect 38: The method of aspect 37, wherein determining the quality of service split further comprises: determining the one or more second quality of service parameters corresponding to the second connection type based at least in part on a 5QI configuration associated with an end-to-end bearer of the first wireless device.

Aspect 39: The method of any of aspects 31 through 38, further comprising: transmitting, to the second wireless device, an indication of the one or more second quality of service parameters corresponding to the second connection type.

Aspect 40: The method of aspect 39, wherein transmitting the indication further comprises: transmitting a radio resource control reconfiguration message comprising the indication of the one or more second quality of service parameters.

Aspect 41: The method of any of aspects 31 through 40, wherein identifying the mapping further comprises: identifying that the mapping between the one or more first quality of service parameters and the one or more second quality of service parameters comprises an association between 5QI table entries to PQI table entries.

Aspect 42: The method of any of aspects 31 through 41, wherein identifying the mapping further comprises: identifying that the mapping between the one or more first quality of service parameters and the one or more second quality of service parameters comprises an association between second connection quality of service flow priority values to first connection quality of service flow priority values.

Aspect 43: The method of any of aspects 31 through 42, wherein identifying the mapping further comprises: identifying that the mapping is associated with the first wireless device in a UE-specific manner, or the mapping is associated with a plurality of first wireless devices.

Aspect 44: The method of any of aspects 31 through 43, wherein the first wireless device, the second wireless device, or both are operating in accordance with resource allocation mode 1 when the first connection is a sidelink connection type, the method further comprising: receiving an indication of an end-to-end bearer identifier associated with the first wireless device, the one or more first quality of service parameters, an identifier of the second wireless device, a reference signal received power associated with the first connection type, or a combination thereof.

Aspect 45: The method of aspect 44, further comprising: determining the one or more first quality of service parameters corresponding to the first connection type based at least in part on the indication and the mapping.

Aspect 46: The method of any of aspects 44 through 45, further comprising: determining mode 1 resources for the first connection based at least in part on the indication.

Aspect 47: The method of any of aspects 31 through 46, wherein the one or more first quality of service parameters, or the one or more second quality of service parameters, or both comprise a priority of the second connection type, prioritized bitrates, a value associated with the second connection type, a resource type, a packet delay budget, a packet error rate, a data burst volume, an averaging window, or a combination thereof.

Aspect 48: The method of any of aspects 31 through 47, wherein the one or more second quality of service parameters are based at least in part on a 5QI of an end-to-end radio bearer.

Aspect 49: An apparatus for wireless communications at a first wireless device, comprising a processor; memory coupled with the processor; and instructions stored in the memory and executable by the processor to cause the apparatus to perform a method of any of aspects 1 through 14.

Aspect 50: An apparatus for wireless communications at a first wireless device, comprising at least one means for performing a method of any of aspects 1 through 14.

Aspect 51: A non-transitory computer-readable medium storing code for wireless communications at a first wireless device, the code comprising instructions executable by a processor to perform a method of any of aspects 1 through 14.

Aspect 52: An apparatus for wireless communications at a first wireless device, comprising a processor; memory coupled with the processor; and instructions stored in the memory and executable by the processor to cause the apparatus to perform a method of any of aspects 15 through 30.

Aspect 53: An apparatus for wireless communications at a first wireless device, comprising at least one means for performing a method of any of aspects 15 through 30.

Aspect 54: A non-transitory computer-readable medium storing code for wireless communications at a first wireless device, the code comprising instructions executable by a processor to perform a method of any of aspects 15 through 30.

Aspect 55: An apparatus for wireless communications at a network entity, comprising a processor; memory coupled with the processor; and instructions stored in the memory and executable by the processor to cause the apparatus to perform a method of any of aspects 31 through 48.

Aspect 56: An apparatus for wireless communications at a network entity, comprising at least one means for performing a method of any of aspects 31 through 48.

Aspect 57: A non-transitory computer-readable medium storing code for wireless communications at a network entity, the code comprising instructions executable by a processor to perform a method of any of aspects 31 through 48.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first wireless device, comprising:
establishing a first connection with a second wireless device that is in communication with a network entity via a second connection, wherein the first connection is of a first connection type and the second connection is of a second connection type;
identifying a mapping between one or more first quality of service parameters corresponding to the first connection type and one or more second quality of service parameters corresponding to the second connection type;
determining, using the mapping, a first quality of service parameter to be applied to the first connection as part of an end-to-end connection with the network entity via the second wireless device; and
communicating with the network entity via the second wireless device using the end-to-end connection.

2. The method of claim 1, further comprising:
receiving an indication of the mapping between the one or more first quality of service parameters corresponding to the first connection type and the one or more second quality of service parameters corresponding to the second connection type.

3. The method of claim 1, further comprising:
receiving an indication of the one or more second quality of service parameters corresponding to the second connection type, wherein determining the first quality of service parameter to be applied to the first connection is based at least in part on the indication.

4. The method of claim 1, further comprising:
transmitting, to the second wireless device, an indication of the first quality of service parameter to be applied to the first connection as part of the end-to-end connection with the network entity via the second wireless device.

5. The method of claim 1, wherein identifying the mapping further comprises:
identifying that the mapping between the one or more first quality of service parameters and the one or more second quality of service parameters comprises an association between 5QI table entries to PQI table entries.

6. The method of claim 1, wherein identifying the mapping further comprises:
identifying that the mapping between the one or more first quality of service parameters and the one or more second quality of service parameters comprises an association between second connection quality of service flow priority values to first connection quality of service flow priority values.

7. The method of claim 1, wherein the first wireless device is operating in accordance with a resource allocation mode 1 when the first connection is a sidelink connection type, the method further comprises:
transmitting an indication of an end-to-end bearer identifier associated with the first wireless device, the one or more first quality of service parameters, an identifier of the second wireless device, a reference signal received power associated with the first connection type, or a combination thereof.

8. A method for wireless communications at a first wireless device, comprising:
establishing a first connection with a second wireless device, wherein the first wireless device is in communication with a network entity via a second connection, the first connection is of a first connection type and the second connection is of a second connection type;
identifying a mapping between one or more first quality of service parameters corresponding to the first connection type and one or more second quality of service parameters corresponding to the second connection type;
determining, using the mapping, a first quality of service parameter to be applied to the first connection as part of an end-to-end connection between the network entity and second wireless device via the first wireless device; and
relaying communications between the network entity and the second wireless device using the end-to-end connection.

9. The method of claim 8, further comprising:
receiving an indication of the mapping between the one or more first quality of service parameters corresponding to the first connection type and the one or more second quality of service parameters corresponding to the second connection type.

10. The method of claim 8, further comprising:
transmitting, to the second wireless device, a first indication of the one or more first quality of service parameters corresponding to the first connection type.

11. The method of claim 8, further comprising:
receiving, from the network entity or the second wireless device, an indication of the one or more second quality of service parameters corresponding to the second connection type, wherein determining the first quality of service parameter to be applied to the first connection is based at least in part on the indication.

12. The method of claim 8, wherein identifying the mapping further comprises:
identifying that the mapping between the one or more first quality of service parameters and the one or more second quality of service parameters comprises an association between 5QI table entries to PQI table entries.

13. The method of claim 8, wherein identifying the mapping further comprises:
identifying that the mapping between the one or more first quality of service parameters and the one or more second quality of service parameters comprises an association between second connection quality of service flow priority values to first connection quality of service flow priority values.

14. The method of claim 8, wherein the first wireless device is operating in accordance with a random access mode 1 when the first connection is a sidelink connection type, the method further comprises:
transmitting an indication of a bearer identifier of the second wireless device, a reference signal received power associated with the first connection type, or a combination thereof.

15. The method of claim 8, further comprising:
determining a first connection type bearer based at least in part on a second connection type bearer; and
transmitting an indication of the second connection type bearer to the second wireless device via a radio resource control reconfiguration message.

16. The method of claim 8, further comprising:
utilizing a first connection type bearer configuration for the second wireless device via a radio resource control reconfiguration message.

17. A method for wireless communications at a network entity, comprising:
establishing an end-to-end connection with a first wireless device via a second wireless device, wherein the end-to-end connection comprises a first connection and a second connection, the network entity being in communication with the second wireless device via the second connection and the second wireless device being in communication with the first wireless device via the first connection, the first connection being of a first connection type and the second connection being of a second connection type;
identifying a mapping between one or more first quality of service parameters corresponding to the first connection type and one or more second quality of service parameters corresponding to the second connection type; and
communicating with the first wireless device via the second wireless device using the end-to-end connection.

18. The method of claim 17, further comprising:
receiving an indication of the mapping between the one or more first quality of service parameters and the one or more second quality of service parameters.

19. The method of claim 18, wherein receiving the indication of the mapping further comprises:
receiving the indication of the mapping from an access and mobility management Function.

20. The method of claim 19, wherein receiving the indication of the mapping further comprises:
receiving the indication of the mapping from a session management function via the access and mobility management Function.

21. The method of claim 18, wherein receiving the indication of the mapping further comprises:
receiving the indication of the mapping during a UE Policy Association Establishment procedure, a UE Policy Association Modification procedure, or both.

22. The method of claim 18, wherein receiving the indication of the mapping further comprises:
receiving the indication of the mapping during a UE Protocol Data Unit session establishment procedure, a UE Protocol Data Unit session modification procedure, or both.

23. The method of claim 17, further comprising:
determining a quality of service split between the first connection and the second connection.

24. The method of claim 23, wherein determining the quality of service split further comprises:
determining the one or more second quality of service parameters corresponding to the second connection type based at least in part on a 5QI configuration associated with an end-to-end bearer of the first wireless device.

25. The method of claim 17, further comprising:
transmitting, to the second wireless device, an indication of the one or more second quality of service parameters corresponding to the second connection type.

26. The method of claim 17, wherein identifying the mapping further comprises:
identifying that the mapping between the one or more first quality of service parameters and the one or more second quality of service parameters comprises an association between 5QI table entries to PQI table entries.

27. The method of claim 17, wherein identifying the mapping further comprises:
identifying that the mapping between the one or more first quality of service parameters and the one or more second quality of service parameters comprises an association between second connection quality of service flow priority values to first connection quality of service flow priority values.

28. The method of claim 17, wherein identifying the mapping further comprises:
identifying that the mapping is associated with the first wireless device in a UE-specific manner, or the mapping is associated with a plurality of first wireless devices.

29. The method of claim 17, wherein the first wireless device, the second wireless device, or both are operating in accordance with resource allocation mode 1 when the first connection is a sidelink connection type, the method further comprising:
receiving an indication of an end-to-end bearer identifier associated with the first wireless device, the one or more first quality of service parameters, an identifier of the second wireless device, a reference signal received power associated with the first connection type, or a combination thereof.

30. An apparatus for wireless communications at a first wireless device, comprising:
a processor;
memory coupled with the processor; and
instructions stored in the memory and executable by the processor to cause the apparatus to:
establish a first connection with a second wireless device that is in communication with a network entity via a second connection, wherein the first connection is of a first connection type and the second connection is of a second connection type;
identify a mapping between one or more first quality of service parameters corresponding to the first connection type and one or more second quality of service parameters corresponding to the second connection type;
determine, using the mapping, a first quality of service parameter to be applied to the first connection as part of an end-to-end connection with the network entity via the second wireless device; and
communicate with the network entity via the second wireless device using the end-to-end connection.
